(19) United States
(12) Patent Application Publication
(10) Pub. No.: US 2014/0205007 A1
(43) Pub. Date: Jul. 24, 2014

(54) IMAGE PROCESSING DEVICES AND METHODS

(71) Applicant: Yoshitomo Takahashi, Kanagawa (JP)

(72) Inventor: Yoshitomo Takahashi, Kanagawa (JP)

(73) Assignee: Sony Corporation, Minato-ku (JP)

(21) Appl. No.: 14/239,641

(22) PCT Filed: Aug. 21, 2012
(86) PCT No.: PCT/JP2012/071029

§ 371 Date: Feb. 19, 2014

(30) Foreign Application Priority Data
Aug. 31, 2011 (JP) 2011-188278

(51) Int. Cl. H04N 19/124; H04N 19/18; H04N 13/00; H04N 19/136

(52) U.S. Cl. CPC H04N 19/0009; H04N 19/00139; H04N 19/00296; H04N 13/0048
USPC 375/240.03

(57) ABSTRACT

The present technique relates to image processing devices and methods that enable quantization processes or inverse quantization processes more suited to the content of each image. An image processing device of the present disclosure includes: a quantization value setter that sets a quantization value of a depth image independently of a texture image, the depth image being multiplexed with the texture image; a quantizer that generates quantized data by quantizing coefficient data of the depth image, using the quantization value of the depth image set by the quantization value setter; and an encoder that generates an encoded stream by encoding the quantized data generated by the quantizer. The present disclosure can be applied to image processing devices.

### TECHNICAL FIELD

The present disclosure relates to image processing devices and methods, and to image processing devices and methods for performing quantization processes and inverse quantization processes.

### BACKGROUND ART

In recent years, to handle image information as digital information and achieve high-efficiency information transmission and accumulation in doing do, apparatuses compliant with a standard, such as MPEG (Moving Picture Experts Group) for compressing image information through orthogonal transforms such as discrete cosine transforms and motion compensation by taking advantage of redundancy inherent to the image information, have been spreading both among broadcast stations that distribute information and among general households that receive information.

Nowadays, there is an increasing demand for encoding at a higher compression rate so as to compress images having a resolution of about 4096×2048 pixels, which is four times higher than the high-definition image resolution, or distribute high-definition images in circumstances where transmission capacities are limited as in the Internet. Therefore, studies on improvement in encoding efficiency are still continued by VCEG (Video Coding Expert Group) under ITU-T (International Telecommunication Union Telecommunication Standardization Sector).

The pixel size of a macroblock that is a partial region in an image and serves as an image dividing unit (an encoding unit) in image encoding according to a conventional image encoding system such as MPEG1, MPEG2, or ITU-T H.264/MPEG4-AVC (Advanced Video Coding), is always 16×16 pixels. Meanwhile, Non-Patent Document 1 suggests increases in the number of pixels in both the horizontal and vertical directions of macroblocks as the elemental technology in next-generation image encoding standards. The document suggests the use of macroblocks each formed with 32×32 pixels or 64×64 pixels, as well as macroblocks each formed with 16×16 pixels as specified by MPEG1, MPEG2, ITU-T H.264/MPEG4-AVC, and the like. This is intended to increase encoding efficiency by performing motion compensation and orthogonal transform on larger regions as units among regions with similar motions, since the horizontal and vertical pixel sizes in images to be encoded are expected to become larger in the future, as with UHD (Ultra High Definition; 4000×2000 pixels).

In Non-Patent Document 1, compatibility with macroblocks of the current AVC is maintained for 16×16 pixel or smaller blocks by employing hierarchical structures, and larger blocks are defined as supersets of those conventional blocks.

While Non-Patent Document 1 suggests the use of extended macroblocks for inter slices, Non-Patent Document 2 suggests the use of extended macroblocks for intra slices.

In the image encoding disclosed in Non-Patent Document 1 or Non-Patent document 2, a quantization process is performed to increase encoding efficiency.

Meanwhile, to encode multi-view images, a method of encoding texture images such as luminance and chrominance, and depth images that are information indicating disparity and depth has been suggested (see Non-Patent Document 3, for example).

### CITATION LIST

### Non-Patent Documents

Non-Patent Document 1: Peisong Chenn, Yan Ye, Marta Karczewicz, “Video Coding Using Extended Block Sizes”, COM16-C123-E, Qualcomm Inc
Non-Patent Document 2: Sung-Chang Lim, Hahyun Lee, Jinho Lee, Jongho Kim, Haechul Choi, Seyoon Jeong, Jin Soo Choi, “Intra coding using extended block size”, VCEG-AL28, July, 2009
Non-Patent Document 3: “Call for Proposals on 3D Video Coding Technology”, ISO/IEC JTC1/SC29/WG11 MPEG2011/N12036, Geneva, Switzerland, March 2011

### SUMMARY OF THE INVENTION

### Problems to be Solved by the Invention

As multi-view images are now encoded as described above, more appropriate quantization needs to be performed on depth images. However, it is difficult to do so by a conventional method.

The present disclosure is made in view of those circumstances, and aims to perform more appropriate quantization processes and prevent degradation of subjective image quality of decoded images.

### Solutions to Problems

One aspect of the present disclosure is an image processing device that includes: a quantization value setter that sets a quantization value of a depth image independently of a texture image, the depth image being multiplexed with the texture image; a quantizer that generates quantized data by quantizing coefficient data of the depth image, using the quantization value of the depth image set by the quantization value setter; and an encoder that generates an encoded stream by encoding the quantized data generated by the quantizer.

The quantization value setter may set a quantization value of the depth image for each predetermined region in the depth image.

The encoder may perform the encoding for each unit having a hierarchical structure, and the region may be a coding unit.

The image processing device may further include: a quantization parameter setter that sets a quantization parameter of a current picture of the depth image, using the quantization value of the depth image set by the quantization value setter; and a transmitter that transmits the quantization parameter set by the quantization parameter setter, and the encoded stream generated by the encoder.

The image processing device may further include: a difference quantization parameter setter that sets a difference quantization parameter that is a difference value between a quantization parameter of a current picture and a quantization parameter of a current slice, using the quantization value of the depth image set by the quantization value setter; and a transmitter that transmits the difference quantization parameter set by the difference quantization parameter setter, and the encoded stream generated by the encoder.

The difference quantization parameter setter may set the difference quantization parameter that is a difference value between a quantization parameter of the coding unit quantized one unit before a current coding unit and a quantization parameter of the current coding unit, using the quantization value of the depth image set by the quantization value setter.

The image processing device may further include: an identification information setter that sets identification information indicating whether a quantization parameter of the depth image has been set; and a transmitter that transmits the identification information set by the identification information setter and the encoded stream generated by the encoder.

The one aspect of the present disclosure is also an image processing method for an image processing device, the method including: setting a quantization value of a depth image independently of a texture image, the depth image being multiplexed with the texture image, the setting the quantization value of the depth image being performed by a quantization value setter; generating quantized data by quantizing coefficient data of the depth image, using the set quantization value of the depth image, the generating the quantized data being performed by a quantizer; and generating an encoded stream by encoding the quantized data generated by the quantizer, the generating the encoded stream being performed by an encoder.

Another aspect of the present disclosure is an image processing device that includes: a receiver that receives a quantization value of a depth image set independently of a texture image, and an encoded stream generated by quantizing and encoding coefficient data of the depth image, the depth image being multiplexed with the texture image; a decoder that decodes the encoded stream received by the receiver, to acquire quantized data generated by quantizing the coefficient data of the depth image; and an inverse quantizer that inversely quantizes the quantized data acquired by the decoder, using the quantization value of the depth image received by the receiver.

The receiver may receive a quantization value of the depth image that is set for each predetermined region in the depth image.

The decoder may decode the encoded stream that is encoded for each unit having a hierarchical structure, and the region may be a coding unit.

The receiver may receive the quantization value of the depth image as a quantization parameter of a current picture of the depth image, the quantization parameter of the current picture being set by using the quantization value of the depth image. The image processing device may further include a quantization value setter that sets a quantization value of the depth image, using the quantization parameter of the current picture of the depth image received by the receiver. The inverse quantizer may inversely quantize the quantized data acquired by the decoder, using the quantization value of the depth image set by the quantization value setter.

The receiver may receive the quantization value of the depth image as a difference quantization parameter that is a difference value between a quantization parameter of a current picture and a quantization parameter of a current slice, the quantization parameters of the current picture and the current slice being set by using the quantization value of the depth image. The image processing device may further include a quantization value setter that sets a quantization value of the depth image, using the difference quantization parameter received by the receiver. The inverse quantizer may inversely quantize the quantized data acquired by the decoder, using the quantization value of the depth image set by the quantization value setter.

The receiver may receive the difference quantization parameter that is a difference value between a quantization parameter of the coding unit quantized one unit before a current coding unit and a quantization parameter of the current coding unit, the quantization parameters being set by using the quantization value of the depth image.

The receiver may further receive identification information indicating whether a quantization parameter of the depth image has been set, and the inverse quantizer may inversely quantize the coefficient data of the depth image only when the identification information indicates that a quantization parameter of the depth image has been set.

The other aspect of the present disclosure is also an image processing method for an image processing device, the method including: receiving a quantization value of a depth image set independently of a texture image, and an encoded stream generated by quantizing and encoding coefficient data of the depth image, the depth image being multiplexed with the texture image, the receiving the quantization value of the depth image and the encoded stream being performed by a receiver; decoding the received encoded stream to acquire quantized data generated by quantizing the coefficient data of the depth image, the decoding the received encoded stream being performed by a decoder; and inversely quantizing the acquired quantized data by using the received quantization value of the depth image, the inversely quantizing the acquired quantized data being performed by an inverse quantizer.

In the one aspect of the present disclosure, a quantization value of a depth image to be multiplexed with a texture image is set independently of the texture image, coefficient data of the depth image is quantized to generate quantized data by using the set quantization value of the depth image, and the generated quantized data is encoded to generate an encoded stream.

In the other aspect of the present disclosure, a quantization parameter value of a depth image that is set independently of the texture image, the depth image being multiplexed with the texture image, and an encoded stream generated by quantizing and encoding coefficient data of the depth image are received. The received encoded stream is decoded to acquire quantized data generated by quantizing the coefficient data of the depth image, and the acquired quantized data is inversely quantized by using the received quantization value of the depth image.

### Effects of the Invention

According to the present disclosure, images can be processed. Particularly, degradation of subjective image quality of decoded images can be prevented.

### BRIEF DESCRIPTION OF DRAWINGS

FIG. 1 is a block diagram showing a typical example structure of a system that performs image processing.

FIG. 2 is a block diagram showing a typical example structure of an image encoding device.

FIG. 3 is a diagram for explaining example structures of coding units.

FIG. 4 is a diagram showing examples of quantization parameters assigned to respective coding units.

FIG. 5 is a block diagram showing a typical example structure of a quantizer.

FIG. 6 is a block diagram showing a typical example structure of a depth quantizer.

FIG. 7 is a table showing an example of syntax in a picture parameter set.

FIG. 8 is a table showing an example of syntax in a slice header.

FIG. 9 is a table showing an example of transform coefficient syntax.

FIG. 10 is a flowchart for explaining an example flow of an encoding process.

FIG. 11 is a flowchart for explaining an example flow of a quantization parameter calculation process.

FIG. 12 is a flowchart for explaining an example flow of a depth quantization parameter calculation process.

FIG. 13 is a flowchart for explaining an example flow of a quantization process.

FIG. 14 is a block diagram showing a typical example structure of an image decoding device to which the present technique is applied.

FIG. 15 is a block diagram showing a typical example structure of an inverse quantizer.

FIG. 16 is a block diagram showing a typical example structure of a depth inverse quantizer.

FIG. 17 is a flowchart for explaining an example flow of a decoding process.

FIG. 18 is a flowchart for explaining an example flow of an inverse quantization process.

FIG. 19 is a flowchart for explaining an example flow of a depth inverse quantization process.

FIG. 20 is a flowchart for explaining another example flow of a depth quantization parameter calculation process.

FIG. 21 is a flowchart for explaining another example flow of a quantization process.

FIG. 22 is a flowchart for explaining another example flow of a depth inverse quantization process.

FIG. 23 is a diagram for explaining disparity and depth.

FIG. 24 is a block diagram showing a typical example structure of a computer to which the present technique is applied.

FIG. 25 is a block diagram showing a typical example structure of a television apparatus to which the present technique is applied.

FIG. 26 is a block diagram showing a typical example structure of a mobile device to which the present technique is applied.

FIG. 27 is a block diagram showing a typical example structure of a recording/reproducing device to which the present technique is applied.

FIG. 28 is a block diagram showing a typical example structure of an imaging device to which the present technique is applied.

### MODES FOR CARRYING OUT THE INVENTION

Modes for carrying out the present disclosure (hereinafter referred to as the embodiments) will be described below. Explanation will be made in the following order.

1. First Embodiment (image encoding device)

2. Second Embodiment (image decoding device)

3. Third Embodiment (image encoding device and image decoding device)

4. Fourth Embodiment (computer)

5. Fifth Embodiment (television receiver)

6. Sixth Embodiment (portable telephone device)

7. Seventh Embodiment (recording/reproducing device)

8. Eighth Embodiment (imaging apparatus)

### 1. First Embodiment

[Description of Depth Images (Disparity Images) in this Specification]

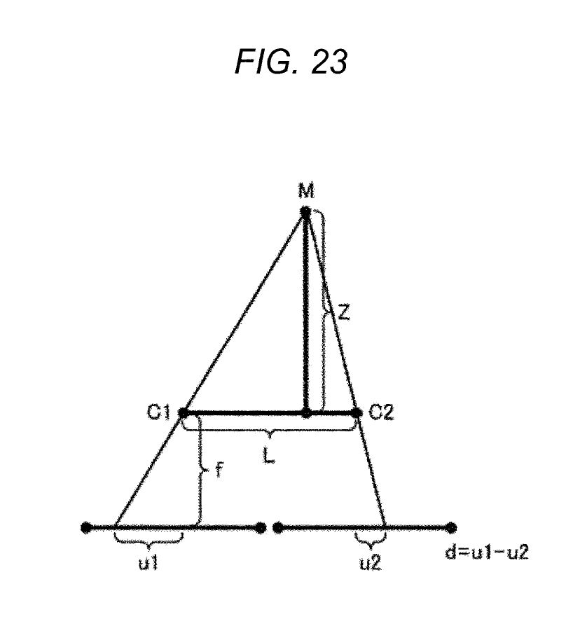

FIG. 23 is a diagram for explaining disparity and depth.

As shown in FIG. 23, when a color image of an object M is captured by a camera c1 located in a position C1 and a camera c2 located in a position C2, the object M has depth Z, which is the distance from the camera c1 (the camera c2) in the depth direction, and is defined by the following equation (a).

[Mathematical Formula 1]

Z=(L/d)×f (a)

Here, L represents the distance between the position C1 and the position C2 in the horizontal direction (hereinafter referred to as the inter-camera distance). Meanwhile, d represents the value obtained by subtracting the distance u2 between the position of the object M in the color image captured by the camera c2 and the center of the color image in the horizontal direction, from the distance u1 between the position of the object M in the color image captured by the camera c1 and the center of the color image in the horizontal direction. That is, d represents disparity. Further, f represents the focal length of the camera c1, and, in the equation (a), the focal lengths of the camera c1 and the camera c2 are the same.

As shown in the equation (a), the disparity d and the depth Z can be uniquely converted. Therefore, in this specification, the image representing the disparity d and the image representing the depth Z of the color image of two viewpoints captured by the camera c1 and the camera c2 are collectively referred to as depth images (disparity images).

A depth image (a disparity image) may be an image representing the disparity d or the depth Z, and a pixel value in a depth image (a disparity image) is not the disparity d as it is or the depth Z as it is but may be a value obtained by normalizing the disparity d, a value obtained by normalizing the reciprocal 1/Z of the depth Z, or the like.

A value I obtained by normalizing the disparity d with 8 bits (0 through 255) can be calculated according to the equation (b) shown below. It should be noted that the number of normalization bits for the disparity d is not limited to 8, but may be some other number such as 10 or 12.

$$\begin{matrix}[ Mathematical Formula 2 ] & \\ I = \frac{255 \times ( d - {D}_{min} )}{{D}_{max} - {D}_{min}} & ( b )\end{matrix}$$

In the equation (b), Dmax represents the maximum value of the disparity d, and Dmin represents the minimum value of the disparity d. The maximum value Dmax and the minimum value Dmin may be set for each screen, or may be set for each set of more than one screen.

A value y obtained by normalizing the reciprocal 1/Z of the depth Z with 8 bits (0 through 255) can be calculated according to the equation (c) shown below. It should be noted that the number of normalization bits for the reciprocal 1/Z of the depth Z is not limited to 8, but may be some other number such as 10 or 12.

$$\begin{matrix}[ Mathematical Formula 3 ] & \\ y = 255 \times \frac{\frac{1}{Z} - \frac{1}{{Z}_{far}}}{\frac{1}{{Z}_{near}} - \frac{1}{{Z}_{far}}} & ( c )\end{matrix}$$

In the equation (c), Zfar represents the maximum value of the depth Z, and Znear represents the minimum value of the depth Z. The maximum value Zfar and the minimum value Znear may be set for each screen, or may be set for each set of more than one screen.

As described above, in this specification, an image having a pixel value I obtained by normalizing the disparity d, and an image having a pixel value y obtained by normalizing the reciprocal 1/Z of the depth Z are collectively referred to as depth images (disparity images), as the disparity d and the depth Z can be uniquely converted. The color format of the depth images (disparity images) is YUV420 or YUV400 format, but may be some other color format.

When attention is focused on the value I or the value y as information, instead of a pixel value in a depth image (a disparity image), the value I or the value y is set as depth information (disparity information). Further, a depth map (a disparity map) is formed by mapping the value I or the value y.

[System]

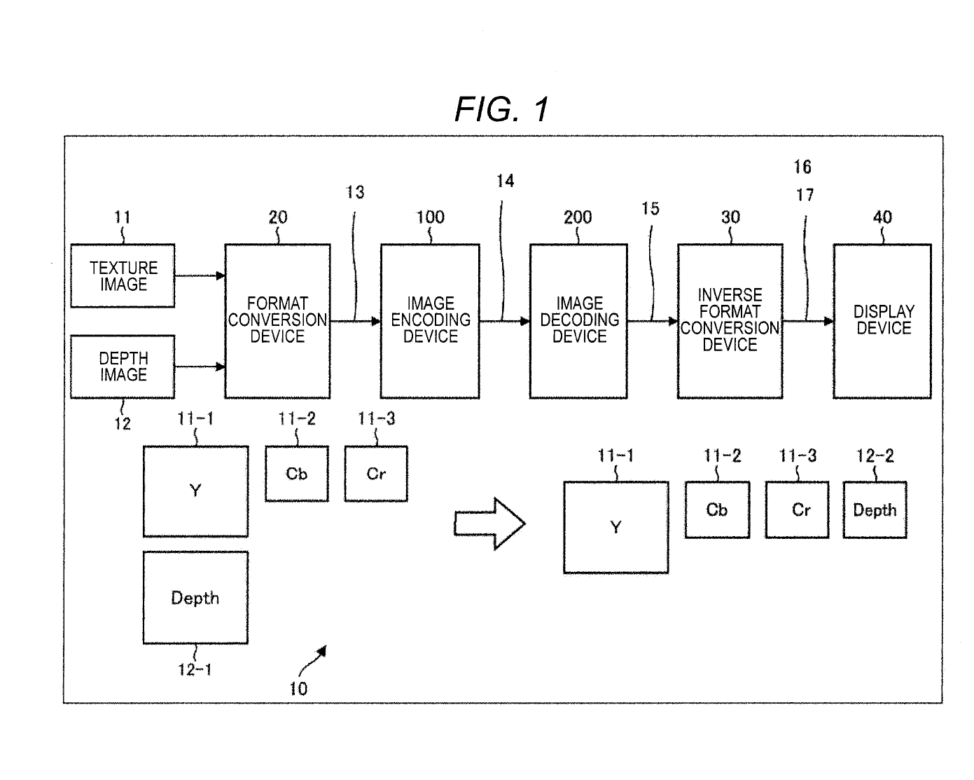

FIG. 1 is a block diagram showing a typical example structure of a system including devices that perform image processing. The system 10 shown in FIG. 1 is a system that transmits image data. At the time of transmission, an image is encoded at the transmitter, is decoded at the destination of the transmission, and is then output. As shown in FIG. 1, the system 10 transmits a multi-view image formed with a texture image 11 and a depth image 12.

The texture image 11 is an image of luminance or chrominance, and the depth image 12 is information indicating a disparity size and a depth for each pixel of the texture image 11. By combining these images, a multi-view image for stereoscopic viewing can be generated. A depth image is not actually output as an image, but each value thereof can be represented by a pixel value, being information about each pixel.

The system 10 includes a format conversion device 20 and an image encoding device 100 that form the image transmitter. The format conversion device 20 multiplexes the texture image 11 and the depth image 12 to be transmitted (or turns these images into components). Acquiring the multiplexed image 13, the image encoding device 100 encodes the image to generate an encoded stream 14, and transmits the encoded stream 14 to the destination of the image transmission.

The system 10 includes an image decoding device 200, an inverse format conversion device 30, and a display device 40 that form the image transmission destination. Acquiring the encoded stream 14 transmitted from the image encoding device 100, the image decoding device 200 decodes the encoded stream 14 to generate a decoded image 15.

The inverse format conversion device 30 inversely converts the format of the decoded image 15, and divides the image into a texture image 16 and a depth image 17. The display device 40 displays the texture image 16 and the depth image 17, respectively.

In a conventional case as disclosed in Non-Patent Document 3, for example, the texture image 11 and the depth image 12 are already encoded, respectively. In the system 10, on the other hand, the format conversion device 20 turns these images into components in a predetermined format, so as to further increase encoding efficiency.

For example, as shown in FIG. 1, the texture image 11 is formed with a luminance image (Y) 11-1, a chrominance image (Cb) 11-2, and a chrominance image (Cr) 11-3, and the luminance image (Y) 11-1 has a resolution that is twice higher than that of the chrominance image (Cb) 11-2 and the chrominance image (Cr) 11-3. The depth image (Depth) 12-1 has the same resolution as the luminance image (Y) 11-1.

The format conversion device 20 reduces the resolution of the depth image 12-1 by half to the resolution of the chrominance image (Cb) 11-2 and the chrominance image (Cr) 11-3, and then multiplexes the texture image 11 and the depth image 12.

While any format can be used at the time of turning the images into components, the image encoding device 100 can perform more efficient encoding as the format conversion device 20 turns the texture image 11 and the depth image 12 into components. For example, various kinds of parameters such as the hierarchical structure of each coding unit, intra prediction information, and motion estimation information can be shared among respective components.

Normally, quantization is preferably performed so that image quality degradation will become less conspicuous in the decoded image. In other words, quantization is preferably performed to protect portions where degradation is easily noticed. However, the regions that need to be protected are not necessarily the same between the texture image 11 and the depth image 12.

In the texture image 11, for example, degradation in the face portion of the object contained in the image and degradation in monotonously-patterned regions are substantively conspicuous. Therefore, protecting such portions is given priority in the texture image 11.

In the depth image 12, on the other hand, degradation is easily noticed in a portion that varies in disparity and greatly affects stereoscopic viewing, such as a boundary between an object in the front and an object in the back. Therefore, protecting such portions is given priority in the depth image 12.

Since the regions that need to be protected differ between the texture image 11 and the depth image 12, there is a possibility that preferred quantization cannot be performed if quantization parameter settings are shared among respective components.

In view of this, the image encoding device 100 controls quantization parameters of components independently of one another, so that more appropriate quantization can be performed to prevent degradation of subjective image quality of decoded images.

[Image Encoding Device]

FIG. 1 is a block diagram showing a typical example structure of an image encoding device.

The image encoding device 100 shown in FIG. 1 encodes image data of multi-view images formed with texture images and depth images by using prediction processes according to an encoding method such as H.264 and MPEG (Moving Picture Experts Group) 4 Part 10 (AVC (Advanced Video Coding)).

As shown in FIG. 1, the image encoding device 100 includes an A/D converter 101, a frame reordering buffer 102, an arithmetic operation unit 103, an orthogonal transformer 104, a quantizer 105, a lossless encoder 106, and an accumulation buffer 107. The image encoding device 100 also includes an inverse quantizer 108, an inverse orthogonal transformer 109, an arithmetic operation unit 110, a loop filter 111, a frame memory 112, a selector 113, an intra predictor 114, a motion estimator/compensator 115, a predicted image selector 116, and a rate controller 117.

The A/D converter 101 performs A/D conversion on input image data, supplies the image data (digital data) obtained by the conversion to the frame reordering buffer 102, and stores the image data therein. The frame reordering buffer 102 rearranges the image having frames stored in display order in accordance with the GOP (Group of Pictures) structure, so that the frames are arranged in frame order for encoding. The image having the frames rearranged is supplied to the arithmetic operation unit 103. The frame reordering buffer 102 also supplies the image having the rearranged frame order to the intra predictor 114 and the motion estimator/compensator 115.

The arithmetic operation unit 103 subtracts a predicted image supplied from the intra predictor 114 or the motion estimator/compensator 115 via the predicted image selector 116 from an image read from the frame reordering buffer 102, and outputs the resultant difference information to the orthogonal transformer 104.

When intra encoding is performed on an image, for example, the arithmetic operation unit 103 subtracts a predicted image supplied from the intra predictor 114, from the image read from the frame reordering buffer 102. When inter encoding is performed on an image, for example, the arithmetic operation unit 103 subtracts a predicted image supplied from the motion estimator/compensator 115, from the image read from the frame reordering buffer 102.

The orthogonal transformer 104 performs orthogonal transform, such as a discrete cosine transform or a Karhunen-Loeve transform, on the difference information supplied from the arithmetic operation unit 103. This orthogonal transform is performed by any appropriate method. The orthogonal transformer 104 supplies the transform coefficient to the quantizer 105.

The quantizer 105 quantizes the transform coefficient supplied from the orthogonal transformer 104. The quantizer 105 sets quantization parameters based on information about a target value of code amount supplied from the rate controller 117, and performs quantization thereof. As will be described later in detail, the quantizer 105 at this point sets quantization parameters for the depth image separately from the texture image, and performs quantization thereof. The quantizer 105 supplies the quantized transform coefficient to the lossless encoder 106.

The lossless encoder 106 encodes the transform coefficient quantized at the quantizer 105 by an appropriate encoding method. Since the coefficient data is quantized under the control of the rate controller 117, the code amount becomes equal to the target value (or approximates the target value) that is set by the rate controller 117.

The lossless encoder 106 obtains intra prediction information containing information indicating an intra prediction mode and the like from the intra predictor 114, and obtains inter prediction information containing information indicating an inter prediction mode, motion vector information, and the like from the motion estimator/compensator 115. The lossless encoder 106 further obtains the filter coefficient and the like used at the loop filter 111.

The lossless encoder 106 encodes those various kinds of information by any appropriate encoding method, and incorporates the information into (or multiplexes the information with) the header information of the encoded data. The lossless encoder 106 supplies the encoded data obtained by the encoding to the accumulation buffer 107 and accumulates the encoded data therein.

The encoding method used by the lossless encoder 106 may be variable-length encoding or arithmetic encoding, for example. The variable-length encoding may be CAVLC (Context-Adaptive Variable Length Coding) specified in H.264/AVC, for example. The arithmetic encoding may be CABAC (Context-Adaptive Binary Arithmetic Coding), for example.

The accumulation buffer 107 temporarily holds the encoded data supplied from the lossless encoder 106. The accumulation buffer 107 outputs the encoded data held therein as a bit stream to a recording device (a recording medium) or a transmission path or the like (not shown) in a later stage, for example, at a predetermined time. That is, encoded respective sets of information are supplied to the decoding side.

The transform coefficient quantized by the quantizer 105 is also supplied to the inverse quantizer 108. The inverse quantizer 108 inversely quantizes the quantized transform coefficient by a method compatible with the quantization performed by the quantizer 105. The inverse quantizer 108 supplies the obtained transform coefficient to the inverse orthogonal transformer 109.

The inverse orthogonal transformer 109 performs inverse orthogonal transform on the transform coefficient supplied from the inverse quantizer 108 by a method compatible with the orthogonal transform process performed by the orthogonal transformer 104. This inverse orthogonal transform may be performed by any method as long as the method is compatible with the orthogonal transform process performed by the orthogonal transformer 104. The output subjected to the inverse orthogonal transform (the locally restored difference information) is supplied to the arithmetic operation unit 110.

The arithmetic operation unit 110 obtains a locally reconstructed image (hereinafter referred as to as the reconstructed image) by adding the predicted image supplied from the intra predictor 114 or the motion estimator/compensator 115 via the predicted image selector 116 to the inverse orthogonal transform result supplied from the inverse orthogonal transformer 109 or the locally restored difference information. The reconstructed image is supplied to the loop filter 111 or the frame memory 112.

The loop filter 111 includes a deblocking filter, an adaptive loop filter or the like, and performs appropriate filtering on the decoded image supplied from the arithmetic operation unit 110. For example, the loop filter 111 performs deblocking filtering on the decoded image to remove block distortion from the decoded image. Also, the loop filter 111 performs loop filtering on the result of the deblocking filtering (the decoded image from which block distortion has been removed) by using a Wiener filter, for example, to improve image quality.

Alternatively, the loop filter 111 may perform any appropriate filtering on the decoded image. The loop filter 111 may also supply information such as a filter coefficient used for the filtering, where necessary, to the lossless encoder 106, so that the information will be encoded.

The loop filter 111 supplies the filtering result (hereinafter referred to as the decoded image) to the frame memory 112.

The frame memory 112 stores the reconstructed image supplied from the arithmetic operation unit 110 and the decoded image supplied from the loop filter 111. The frame memory 112 supplies the stored reconstructed image to the intra predictor 114 via the selector 113 at a predetermined time or in response to a request from an outside unit such as the intra predictor 114. The frame memory 112 also supplies the stored decoded image to the motion estimator/compensator 115 via the selector 113 at a predetermined time or in response to a request from an outside unit such as the motion estimator/compensator 115.

The selector 113 indicates a supply destination of an image output from the frame memory 112. In the case of an intra prediction, for example, the selector 113 reads an unfiltered image (the reconstructed image) from the frame memory 112, and supplies the read image as peripheral pixels to the intra predictor 114.

In an inter prediction, for example, the selector 113 reads a filtered image (the decoded image) from the frame memory 112, and supplies the read image as a reference image to the motion estimator/compensator 115.

When obtaining an image (a peripheral image) of a peripheral region located in the periphery of the region being processed (the current region) from the frame memory 112, the intra predictor 114 performs an intra prediction (an intra-screen prediction) to generate a predicted image by using the pixel value of the peripheral image, with a processing unit basically being a prediction unit (PU). The intra predictor 114 performs intra predictions in more than one mode (intra prediction modes) that are prepared in advance.

The intra predictor 114 generates predicted images in all the candidate intra prediction modes, evaluates the cost function values of the respective predicted images by using the input image supplied from the frame reordering buffer 102, and selects an optimum mode. After selecting the optimum intra prediction mode, the intra predictor 114 supplies the predicted image generated in the optimum intra prediction mode to the predicted image selector 116.

The intra predictor 114 also supplies intra prediction information containing information about intra predictions such as an optimum intra prediction mode to the lossless encoder 106, where necessary, so that the information will be encoded.

Using the input image supplied from the frame reordering buffer 102, and the reference image supplied from the frame memory 112, the motion estimator/compensator 115 performs motion estimation (inter predictions), and performs a motion compensation process in accordance with the detected motion vectors, to generate a predicted image (inter-predicted image information). In the motion estimation, a PU is used basically as a processing unit. The motion estimator/compensator 115 performs such inter predictions in more than one mode (inter prediction modes) that are prepared in advance.

The motion estimator/compensator 115 generates predicted images in all the candidate inter prediction modes, evaluates the cost function values of the respective predicted images, and selects an optimum mode. After selecting the optimum inter prediction mode, the motion estimator/compensator 115 supplies the predicted image generated in the optimum intra prediction mode to the predicted image selector 116.

The motion estimator/compensator 115 also supplies the inter prediction information containing the information about inter prediction such as the optimum inter prediction mode to the lossless encoder 106, so that information will be encoded.

The predicted image selector 116 selects the supplier of a predicted image to be supplied to the arithmetic operation unit 103 and the arithmetic operation unit 110. In the case of intra encoding, for example, the predicted image selector 116 selects the intra predictor 114 as the supplier of a predicted image, and supplies the predicted image supplied from the intra predictor 114, to the arithmetic operation unit 103 and the arithmetic operation unit 110. In the case of inter encoding, for example, the predicted image selector 116 selects the motion estimator/compensator 115 as the supplier of a predicted image, and supplies the predicted image supplied from the motion estimator/compensator 115, to the arithmetic operation unit 103 and the arithmetic operation unit 110.

Based on the code amount of the encoded data accumulated in the accumulation buffer 107, the rate controller 117 controls the quantization operation rate of the quantizer 105 so that an overflow or underflow will not occur.

[Coding Unit]

In the following, coding units that are defined by the HEVC coding method are first described.

Coding units (CUs) are also called Coding Tree Blocks (CTBs), and are partial regions of picture-based images that have the same roles as those of macroblocks in AVC. While the size of the latter is limited to the size of 16×16 pixels, the size of the former is not limited to a certain size, and may be designated by the compressed image information in each sequence.

Particularly, a CU of the largest size is referred to as an LCU (Largest Coding Unit), and a CU of the smallest size is referred to as an SCU (Smallest Coding Unit). In a sequence parameter set contained in compressed image information, for example, sizes of those regions are designated, but each of the sizes is limited to a size that is of a square shape and can be represented by a power of 2.

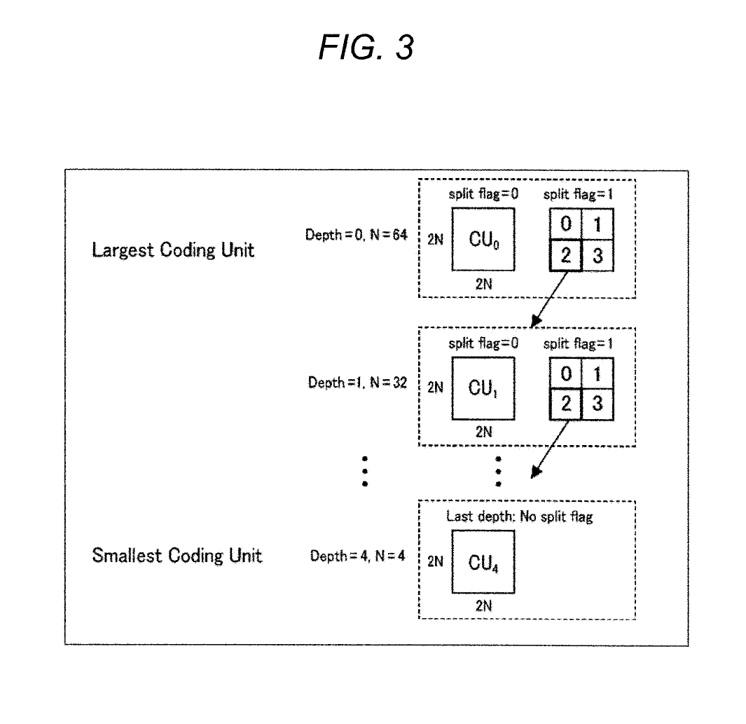

FIG. 3 shows an example of a coding unit defined by HEVC. In the example shown in FIG. 3, the size of the LCU is 128, and the greatest hierarchical depth is 5. When the value of split_flag is “1”, a CU of 2N×2N in size is divided into CUs of N×N in size, which is one hierarchical level lower.

Each of the CUs is further divided into prediction units (PUs) that are processing-unit regions (partial regions of picture-based images) for intra or inter predictions, or are divided into transform units (TUs) that are processing-unit regions (partial regions of picture-based images) for orthogonal transforms.

In the following, “regions” include (or may be any of) all the above mentioned regions (such as macroblocks, sub-macroblocks, LCUs, CUs, SCUs, PUs, and TUs).

“Regions” may of course include a unit other than the above mentioned units, and any improbable unit will be excluded depending on the context.

[Quantization Parameter Assignment]

The image encoding device 100 sets a quantization parameter for each coding unit (CU), so that quantization can be performed more adaptively with respect to the characteristics of each region in an image. However, if the quantization parameters of the respective coding units are transmitted as they are, there is a possibility that encoding efficiency is greatly lowered. Therefore, the quantizer 105 transmits the difference value ΔQP (a difference quantization parameter) between the quantization parameter QP of the last-encoded coding unit and the quantization parameter QP of the coding unit being currently processed (the current coding unit) to the decoding side so as to further increase encoding efficiency.

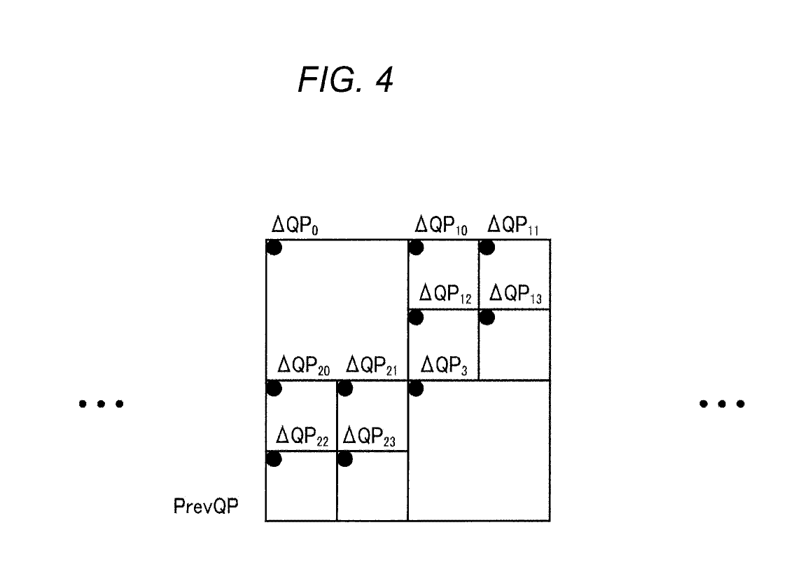

FIG. 4 shows an example of arrangement of coding units in an LCU, and examples of quantization parameter difference values assigned to the respective coding units. As shown in FIG. 4, the difference value ΔQP between the quantization parameter of the last-processed coding unit and the quantization parameter of the coding unit being currently processed (the current coding unit) is assigned as a quantization parameter to each coding unit (CU) by the quantizer 105.

When the upper left coding unit 0 in this LCU is the coding unit being processed (the current coding unit), the quantizer 105 transmits the difference value ΔQP₀ between the quantization parameter of the coding unit processed immediately before this LCU and the quantization parameter of the coding unit 0 to the decoding side.

When the upper left coding unit 10 among the four upper right coding units in the LCU is the coding unit being processed (the current coding unit), the quantizer 105 transmits the difference value ΔQP₁₀ between the quantization parameter of the last-processed coding unit 0 and the quantization parameter of the coding unit 10 to the decoding side.

As for the upper right coding unit 11 among the four upper right coding units in the LCU, the quantizer 105 transmits the difference value ΔQP₁₁ between the quantization parameter of the last-processed coding unit 10 and the quantization parameter of the coding unit 11 to the decoding side. As for the lower left coding unit 12 among the four upper right coding units in the LCU, the quantizer 105 transmits the difference value ΔQP₁₂ between the quantization parameter of the last-processed coding unit 11 and the quantization parameter of the coding unit 12 to the decoding side.

Thereafter, the quantizer 105 calculates a quantization parameter difference value for each coding unit in the same manner, and transmits the difference values to the decoding side.

On the decoding side, the quantization parameter of the coding unit to be processed next can be readily calculated by using the difference value between the quantization parameter of the last-processed coding unit and the quantization parameter assigned to the current coding unit.

As will be described later in detail, as for the top coding unit in a slice, the quantizer 105 transmits the difference value between the quantization parameter of the slice and the quantization parameter of the coding unit to the decoding side. Also, as for a slice, the quantizer 105 transmits the difference value between the quantization parameter of a picture (the current picture) and the quantization parameter of the slice (the current slice) to the decoding side. The quantization parameter of the picture (the current picture) is also transmitted to the decoding side.

Further, the quantizer 105 performs a process related to the setting of such quantization parameters and a quantization process using the quantization parameters for a depth image, independently of processes for a texture image.

In this manner, the quantizer 105 can perform quantization more adaptively with respect to the characteristics of the respective regions in an image.

[Quantizer]

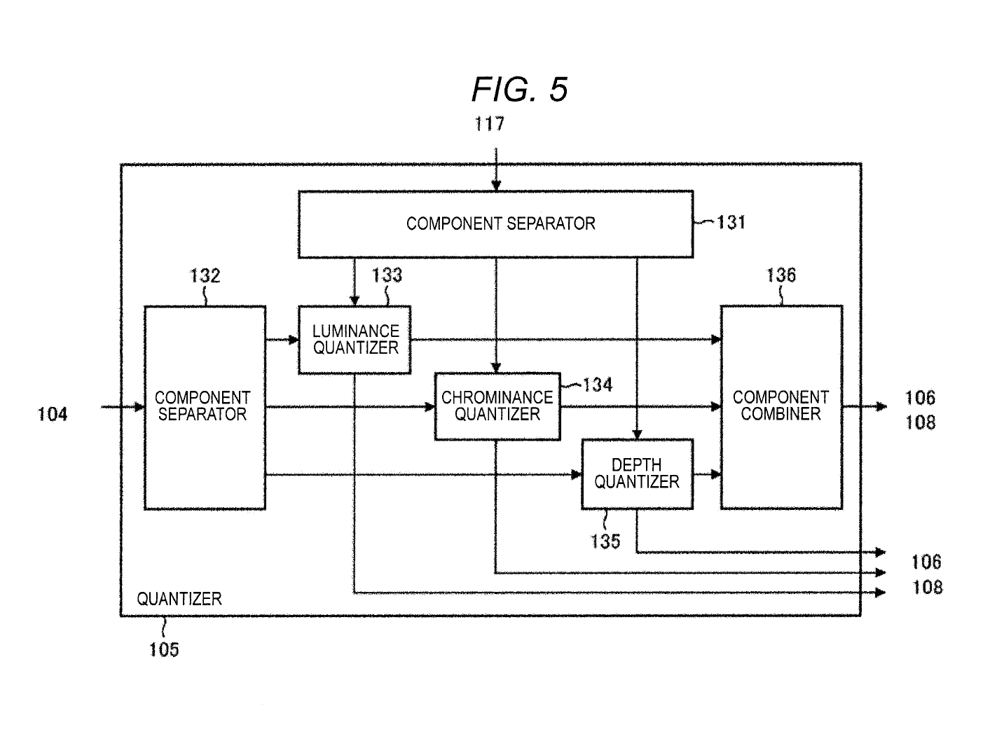

FIG. 5 is a block diagram showing a typical example structure of the quantizer 105.

As shown in FIG. 5, the quantizer 105 includes a component separator 131, a component separator 132, a luminance quantizer 133, a chrominance quantizer 134, a depth quantizer 135, and a component combiner 136.

The component separator 131 separates activities supplied from the rate controller 117 for each component, and supplies the activity of each component to the processor of the same component. For example, the component separator 131 supplies an activity related to a luminance image to the luminance quantizer 133, supplies an activity related to a chrominance image to the chrominance quantizer 134, and an activity related to a depth image to the depth quantizer 135.

The component separator 132 separates orthogonal transform coefficients supplies from the orthogonal transformer 104 for each component, and supplies the orthogonal transform coefficient of each component to the processor of the same component. For example, the component separator 132 supplies the orthogonal transform coefficient of a luminance component to the luminance quantizer 133, supplies the orthogonal transform coefficient of a chrominance component to the chrominance quantizer 134, and supplies the orthogonal transform coefficient of a depth component to the depth quantizer 135.

The luminance quantizer 133 sets quantization parameters related to a luminance component by using an activity supplied from the component separator 131, and quantizes the orthogonal transform coefficient of the luminance component supplied from the component separator 132. The luminance quantizer 133 supplies the quantized orthogonal transform coefficient to the component combiner 136. The luminance quantizer 133 also supplies the quantization parameters related to the luminance component to the lossless encoder 106 and the inverse quantizer 108.

The chrominance quantizer 134 sets quantization parameters related to a chrominance component by using an activity supplied from the component separator 131, and quantizes the orthogonal transform coefficient of the chrominance component supplied from the component separator 132. The chrominance quantizer 134 supplies the quantized orthogonal transform coefficient to the component combiner 136. The chrominance quantizer 134 also supplies the quantization parameters related to the chrominance component to the lossless encoder 106 and the inverse quantizer 108.

The depth quantizer 135 sets quantization parameters related to a depth component by using an activity supplied from the component separator 131, and quantizes the orthogonal transform coefficient of the depth component supplied from the component separator 132. The depth quantizer 135 supplies the quantized orthogonal transform coefficient to the component combiner 136. The depth quantizer 135 also supplies the quantization parameters related to the depth component to the lossless encoder 106 and the inverse quantizer 108.

The component combiner 136 combines the respective orthogonal transform coefficients of each component supplied from the luminance quantizer 133, the chrominance quantizer 134, and the depth quantizer 135, and supplies the combined orthogonal transform coefficients to the lossless encoder 106 and the inverse quantizer 108.

[Depth Quantizer]

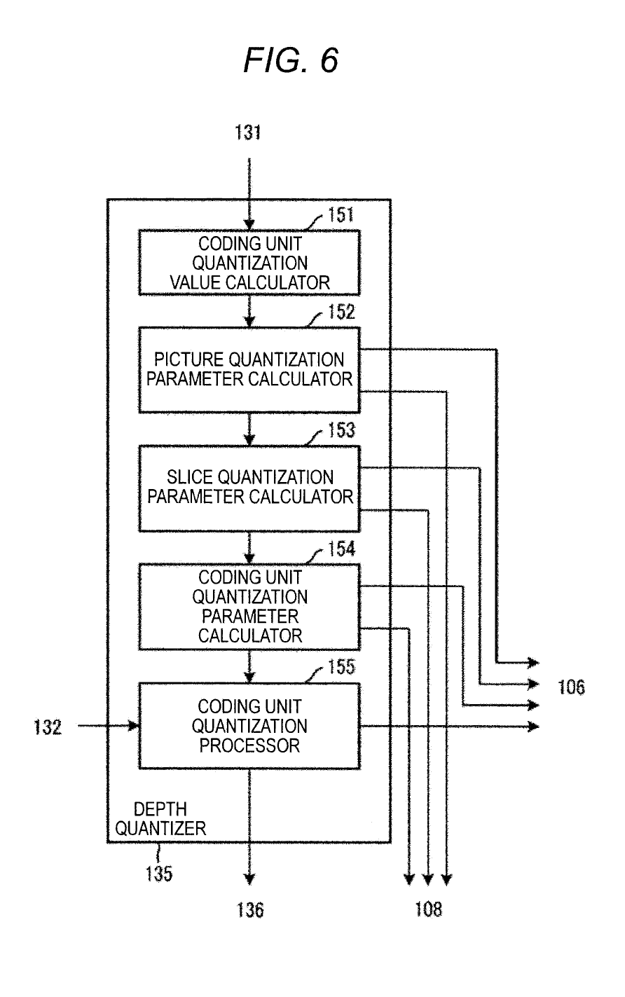

FIG. 6 is a block diagram showing a typical example structure of the depth quantizer 135 shown in FIG. 5.

As shown in FIG. 6, the depth quantizer 135 includes a coding unit quantization value calculator 151, a picture quantization parameter calculator 152, a slice quantization parameter calculator 153, a coding unit quantization parameter calculator 154, and a coding unit quantization processor 155.

The coding unit quantization value calculator 151 calculates the quantization value of each coding unit of a depth image based on the activity of each coding unit of the depth image (information indicating the complexity of the image of each coding unit) supplied from the component separator 131 (the rate controller 117).

After calculating a quantization value for each coding unit, the coding unit quantization value calculator 151 supplies the quantization value of each coding unit to the picture quantization parameter calculator 152.

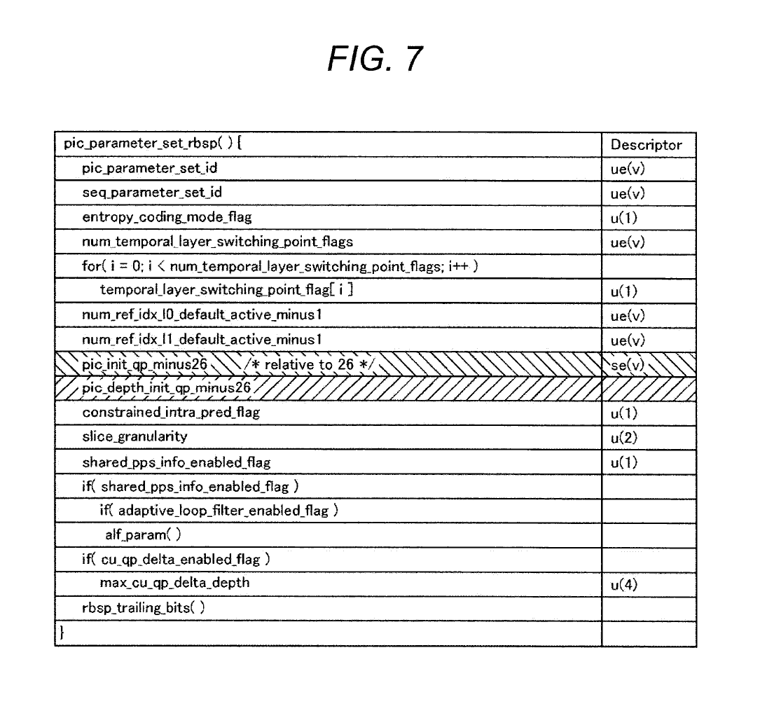

Using the quantization value of each coding unit, the picture quantization parameter calculator 152 calculates the quantization parameter pic_depth_init_qp_minus26 of each picture (current picture) of the depth image. The picture quantization parameter calculator 152 supplies the generated quantization parameter pic_depth_init_qp_minus26 of each picture (current picture) of the depth image to the lossless encoder 106. This quantization parameter pic_depth_init_qp_minus26 is included in a picture parameter set and is then transmitted to the decoding side, as described in the syntax of the picture parameter set shown in FIG. 7.

As shown in FIG. 7, the quantization parameter pic_depth_init_qp_minus26 of each picture (current picture) of the depth image is set in the picture parameter set, independently of the quantization parameter pic_init_qp_minus26 of each picture (current picture) of the texture image.

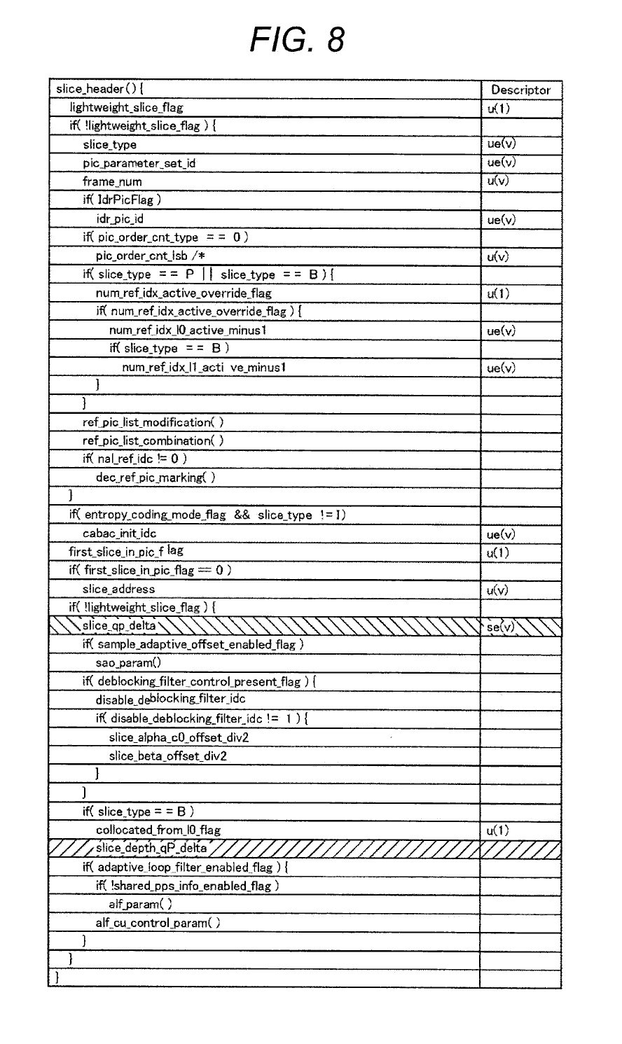

Using the quantization value of each coding unit and the quantization parameter pic_depth_init_qp_minus26 of each picture (current picture), the slice quantization parameter calculator 153 calculates the quantization parameter slice_depth_qp_delta of each slice (current slice) of the depth image. The slice quantization parameter calculator 153 supplies the generated quantization parameter slice_depth_qp_delta of each slice (current slice) of the depth image to the lossless encoder 106. This quantization parameter slice_depth_qp_delta is included in a slice header and is then transmitted to the decoding side, as described in the syntax of the slice header shown in FIG. 8.

As shown in FIG. 8, the quantization parameter slice_depth_qp_delta of each slice (current slice) of the depth image is set in the slice header, independently of the quantization parameter slice_qp_delta of each slice (current slice) of the texture image. In the example shown in FIG. 8, slice_depth_qp_delta is written in the last extended region in the slice header syntax. With this description, a device that does not have a function to set independent quantization parameters for a depth image can use this syntax (or can maintain compatibility).

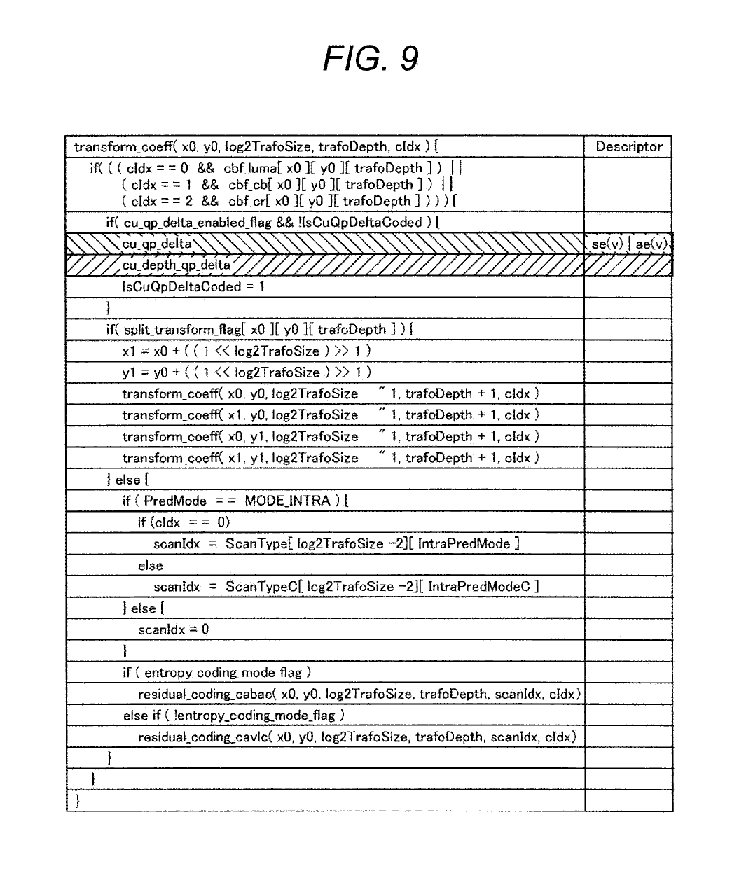

Using the quantization parameter slice_depth_qp_delta of each slice (current slice) and the quantization parameters prevQP used in the last encoding, the coding unit quantization parameter calculator 154 calculates the quantization parameter cu_depth_qp_delta of each coding unit of the depth image. The coding unit quantization parameter calculator 154 supplies the generated quantization parameter cu_depth_qp_delta of each coding unit of the depth image to the lossless encoder 106. This quantization parameter cu_depth_qp_delta is included in a coding unit and is then transmitted to the decoding side, as described in the transform coefficient syntax shown in FIG. 9.

As shown in FIG. 9, the quantization parameter cu_depth_qp_delta of each coding unit of the depth image is set in the coding unit, independently of the quantization parameter cu_qp_delta of each coding unit of the texture image.

The respective quantization parameters generated by the picture quantization parameter calculator 152 through the coding unit quantization parameter calculator 154 are also supplied to the inverse quantizer 108.

Using the quantization value of each coding unit of the depth image, the coding unit quantization processor 155 quantizes the orthogonal transform coefficient of the coding unit being processed (the current coding unit) in the depth image, the orthogonal transform coefficient being supplied from the component separator 132.

The coding unit quantization processor 155 supplies the orthogonal transform coefficient of the depth image quantized for each coding unit to the component combiner 136.

As described above, respective quantization parameters are set for a depth image, independently of a texture image. Accordingly, the image encoding device 100 can perform more appropriate quantization and inverse quantization processes, and can prevent degradation of subjective image quality of decoded images. Also, the above described quantization parameters for a depth image are transmitted to the decoding side. Accordingly, the image encoding device 100 can cause the destination image decoding device 200 to perform more appropriate quantization and inverse quantization processes.

[Flow of Encoding Process]

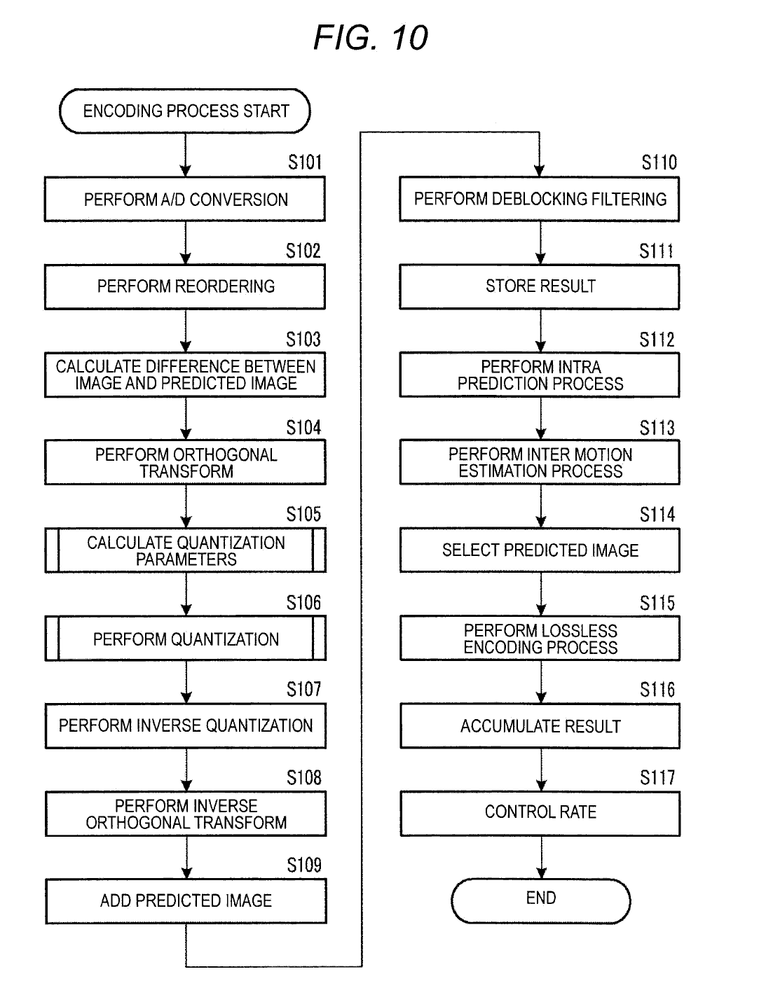

Next, flows of respective processes to be performed by the above described image encoding device 100 are described. Referring first to the flowchart shown in FIG. 10, an example flow of an encoding process is described.

In step S101, the A/D converter 101 performs A/D conversion on an input image. In step S102, the frame reordering buffer 102 stores the image obtained by the A/D conversion and reorders respective pictures in display order into encoding order.

In step S103, the arithmetic operation unit 103 calculates the difference between the image rearranged by the processing in step S102 and a predicted image. The predicted image is supplied to the arithmetic operation unit 103 via the predicted image selector 116 from the motion estimator/compensator 115 when an inter prediction is performed, and from the intra predictor 114 when an intra prediction is performed.

The data amount of the difference data is made smaller than the original image data. Accordingly, the data amount can be made smaller than in a case where images are directly encoded.

In step S104, the orthogonal transformer 104 performs orthogonal transform on the difference information generated by the processing in step S103. Specifically, orthogonal transform such as discrete cosine transform or Karhunen-Loeve transform is performed and a transform coefficient is output.

In step S105, the quantizer 105 calculates quantization parameters. In step S106, the quantizer 105 quantizes the orthogonal transform coefficient obtained by the processing in step S104, using the quantization parameters and the like calculated by the processing in step S105. At this point, independently of the texture image, the quantizer 105 calculates the quantization parameters for the depth image turned into components together with the texture image, and performs quantization using the quantization parameters. By doing so, the quantizer 105 can perform a more appropriate quantization process on the depth image.

The difference information quantized by the processing in step S106 is locally decoded as follows. Specifically, in step S107, the inverse quantizer 108 performs inverse quantization, using the quantization parameters calculated by the processing in step S105. This inverse quantization process is performed in the same manner as in the image decoding device 200. Therefore, explanation of inverse quantization will be made in the description of the image decoding device 200.

In step S108, the inverse orthogonal transformer 109 performs inverse orthogonal transform on the orthogonal transform coefficient obtained by the processing in step S107, using characteristics compatible with those of the orthogonal transformer 104.

In step S109, the arithmetic operation unit 110 adds the predicted image to the locally decoded difference information, to generate a locally decoded image (an image corresponding to the input to the arithmetic operation unit 103). In step S110, the loop filter 111 performs filtering on the image generated by the processing in step S109. As a result, block distortion is removed.

In step S111, the frame memory 112 stores the image having block distortion removed by the processing in step S110. Note that images that are not subjected to the filtering by the loop filter 111 are also supplied from the arithmetic operation unit 110 and stored in the frame memory 112.

In step S112, the intra predictor 114 performs an intra prediction process in an intra prediction mode. In step S113, the motion estimator/compensator 115 performs an inter motion estimation process in which motion estimation and motion compensation are performed in an inter prediction mode.

In step S114, the predicted image selector 116 determines an optimum prediction mode based on cost function values output from the intra predictor 114 and the motion estimator/compensator 115. Specifically, the predicted image selector 116 selects either a predicted image generated by the intra predictor 114 or a predicted image generated by the motion estimator/compensator 115.

Selection information indicating which predicted image has been selected is supplied to the intra predictor 114 or the motion estimator/compensator 115, whichever has generated the selected predicted image. When the predicted image generated in the optimum intra prediction mode is selected, the intra predictor 114 supplies the information indicating the optimum intra prediction mode (or intra prediction mode information) to the lossless encoder 106.

When the predicted image generated in the optimum inter prediction mode is selected, the motion estimator/compensator 115 outputs the information indicating the optimum inter prediction mode, as well as information according to the optimum inter prediction mode, if necessary, to the lossless encoder 106. The information according to the optimum inter prediction mode may be motion vector information, flag information, reference frame information, or the like.

In step S115, the lossless encoder 106 encodes the transform coefficient quantized by the processing in step S106. Specifically, lossless encoding such as variable-length encoding or arithmetic encoding is performed on the difference image (a second-order difference image in the case of an inter prediction).

The lossless encoder 106 also encodes the quantization parameters calculated in step S105, and adds the parameters to the encoded data. That is, the lossless encoder 106 also adds the quantization parameters generated for the depth image to the encoded data.

The lossless encoder 106 also encodes information about the prediction mode of the predicted image selected by the processing in step S114, and adds the encoded information to the encoded data obtained by encoding the difference image. Specifically, the lossless encoder 106 also encodes the intra prediction mode information supplied from the intra predictor 114 or the information according to the optimum inter prediction mode supplied from the motion estimator/compensator 115, and adds the encoded information to the encoded data. These pieces of information is shared among all components.

In step S116, the accumulation buffer 107 accumulates the encoded data that is output from the lossless encoder 106. The encoded data accumulated in the accumulation buffer 107 is read where appropriate, and is transmitted to the decoding side via a transmission path.

In step S117, based on the compressed images accumulated in the accumulation buffer 107 by the processing in step S116, the rate controller 117 controls the quantization operation rate of the quantizer 105 so that an overflow or underflow will not occur.

After the processing in step S117 is completed, the encoding process comes to an end.

[Flow of the Quantization Parameter Calculation Process]

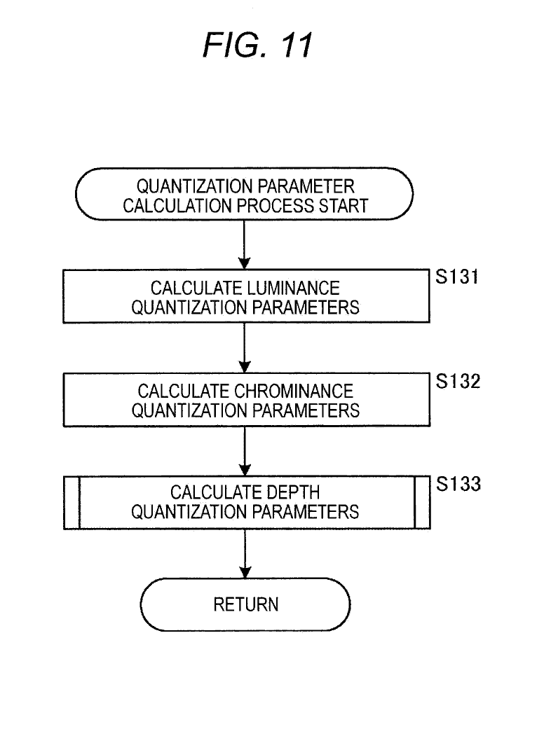

Referring now to the flowchart shown in FIG. 11, an example flow of the quantization parameter calculation process is described. When the quantization parameter process is started, the luminance quantizer 133 in step S131 calculates quantization parameters for the luminance component. In step S132, the chrominance quantizer 134 calculates chrominance quantization parameters. In step S133, the depth quantizer 135 calculates depth quantization parameters.

After the processing in step S133 is completed, the quantizer 105 ends the quantization parameter calculation process, and returns to the process shown in FIG. 10.

[Flow of the Depth Quantization Parameter Calculation Process]

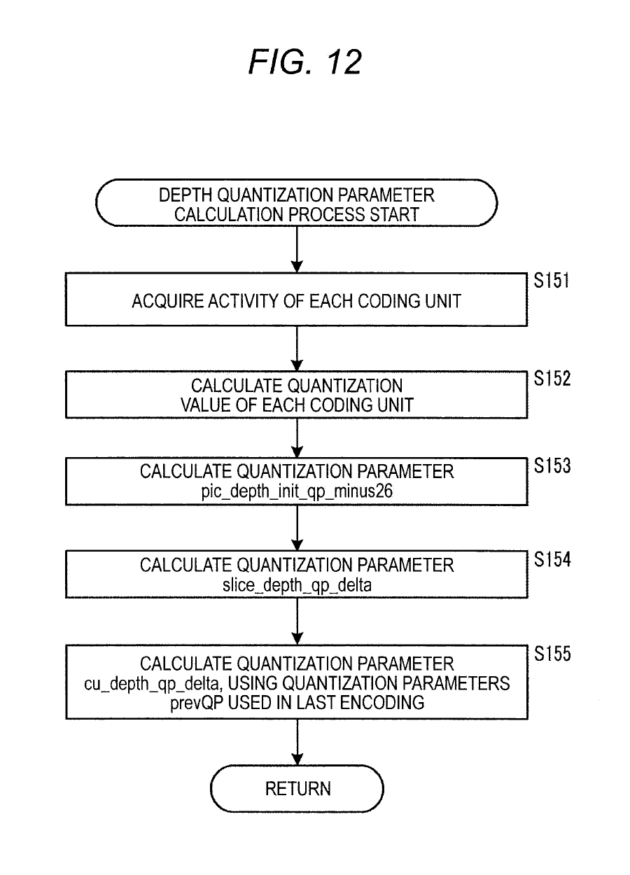

Referring now to the flowchart shown in FIG. 12, an example flow of the depth quantization parameter calculation process performed in step S133 in FIG. 11 is described.

When the depth quantization parameter calculation process is started, the coding unit quantization value calculator 151 in step S151 acquires the activity of each coding unit of the depth image supplied from the rate controller 117.

In step S152, the coding unit quantization value calculator 151 calculates the quantization value of each coding unit of the depth image, using the activity of each coding unit of the depth image.

In step S153, the picture quantization parameter calculator 152 calculates the quantization parameter pic_depth_init_qp_minus26 of each picture (current picture) of the depth image, using the quantization value of each coding unit of the depth image calculated in step S152.

In step S154, the slice quantization parameter calculator 153 calculates the quantization parameter slice_depth_qp_delta of each slice (current slice) of the depth image, using the quantization value of each coding unit of the depth image calculated in step S152 and the quantization parameter pic_depth_init_qp_minus26 of each picture (current picture) of the depth image calculated in step S153.

In step S155, the coding unit quantization parameter calculator 154 calculates the quantization parameter cu_depth_qp_delta of each coding unit of the depth image (such as ΔQP0 through ΔQP23 in FIG. 4), using the quantization parameter slice_depth_qp_delta of each slice (current slice) of the depth image calculated in step S153 and the quantization parameters prevQP used in the last encoding.

After calculating the respective quantization parameters in the above manner, the depth quantizer 135 ends the quantization parameter calculation process, and returns to the process shown in FIG. 11.

[Flow of the Quantization Process]

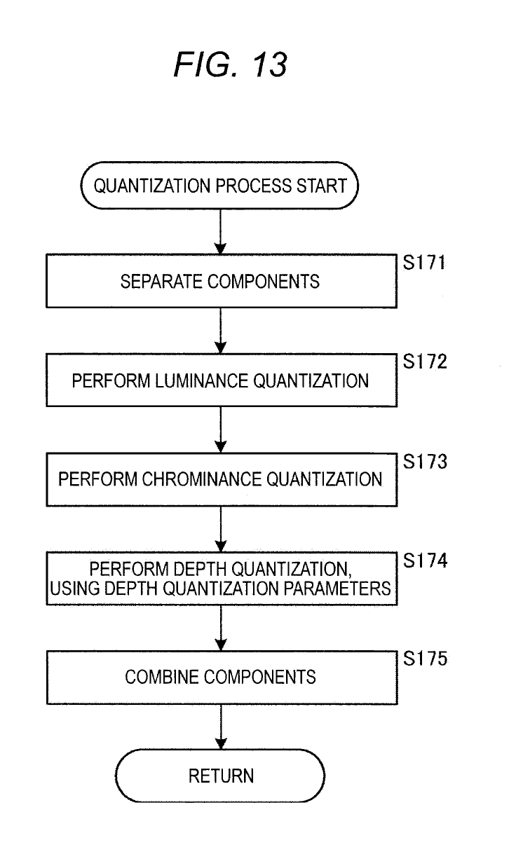

Referring now to the flowchart shown in FIG. 13, an example flow of the quantization process performed in step S106 in FIG. 10 is described.

When the quantization process is started, the component separator 132 in step S171 separates components of the orthogonal transform coefficient supplied from the orthogonal transformer 104.

In step S172, the luminance quantizer 133 performs quantization on the luminance image, using the quantization parameters for the luminance component calculated in step S131 in FIG. 11. In step S173, the chrominance quantizer 134 performs quantization on the chrominance image, using the quantization parameters for the chrominance component calculated in step S132 in FIG. 11. In step S174, the depth quantizer 135 (the coding unit quantization processor 155) performs quantization on the depth image, using the quantization parameters for the depth component calculated in the respective steps in FIG. 12.

In step S175, the component combiner 136 combines the quantized orthogonal transform coefficients of the respective components obtained by the processing in steps S172 through S174. After the processing in step S175 is completed, the quantizer 105 ends the quantization process, and returns to the process shown in FIG. 10, so that the subsequent processing is repeated.

By performing the respective processes as described above, the image encoding device 100 can set quantization parameters for the depth image, independently of the texture image. Also, by performing the quantization process using the quantization parameters, the image encoding device 100 can perform the quantization process for the depth image, independently of the texture image. Accordingly, the image encoding device 100 can perform a more appropriate quantization process for the depth image turned into components together with the texture image.

Also, by performing the encoding process and the quantization parameter calculation process as described above, the image encoding device 100 can set a quantization value for each coding unit, and can perform a more appropriate quantization process in accordance with the content of the image.

That is, the image encoding device 100 can prevent degradation of subjective image quality of the decoded image.

Furthermore, by transmitting the quantization parameters calculated in the above described manner to the image decoding device 200, the image encoding device 100 can cause the image decoding device 200 to perform inverse quantization on the depth image, independently of the texture image. Further, the image encoding device 100 can perform inverse quantization on each coding unit.

It should be noted that the inverse quantizer 108 of the image encoding device 100 performs the same processing as that to be performed by the inverse quantizer 203 of the image decoding device 200 compatible with the image encoding device 100. That is, the image encoding device 100 can also perform inverse quantization on each coding unit.

### 2. Second Embodiment

### [Image Decoding Device]

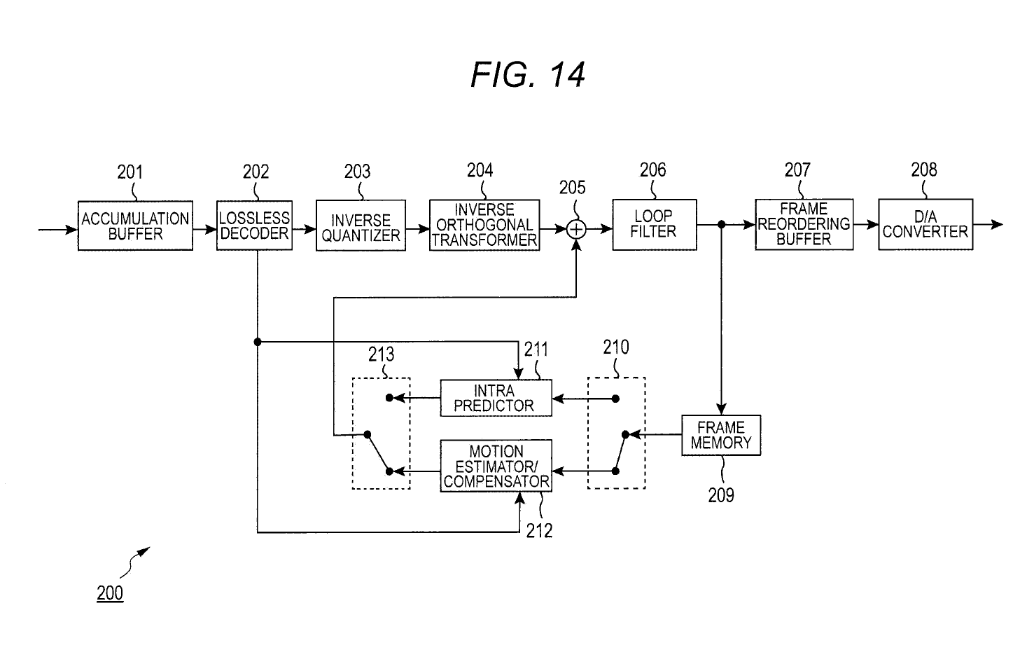

FIG. 14 is a block diagram showing a typical example structure of an image decoding device to which the present technique is applied. The image decoding device 200 shown in FIG. 14 is compatible with the above described image encoding device 100, and correctly decodes a bit stream (encoded data) generated by the image encoding device 100 encoding image data, to generate a decoded image.

As shown in FIG. 14, the image decoding device 200 includes an accumulation buffer 201, a lossless decoder 202, an inverse quantizer 203, an inverse orthogonal transformer 204, an arithmetic operation unit 205, a loop filter 206, a frame reordering buffer 207, and a D/A converter 208. The image decoding device 200 also includes a frame memory 209, a selector 210, an intra predictor 211, a motion estimator/compensator 212, and a selector 213.

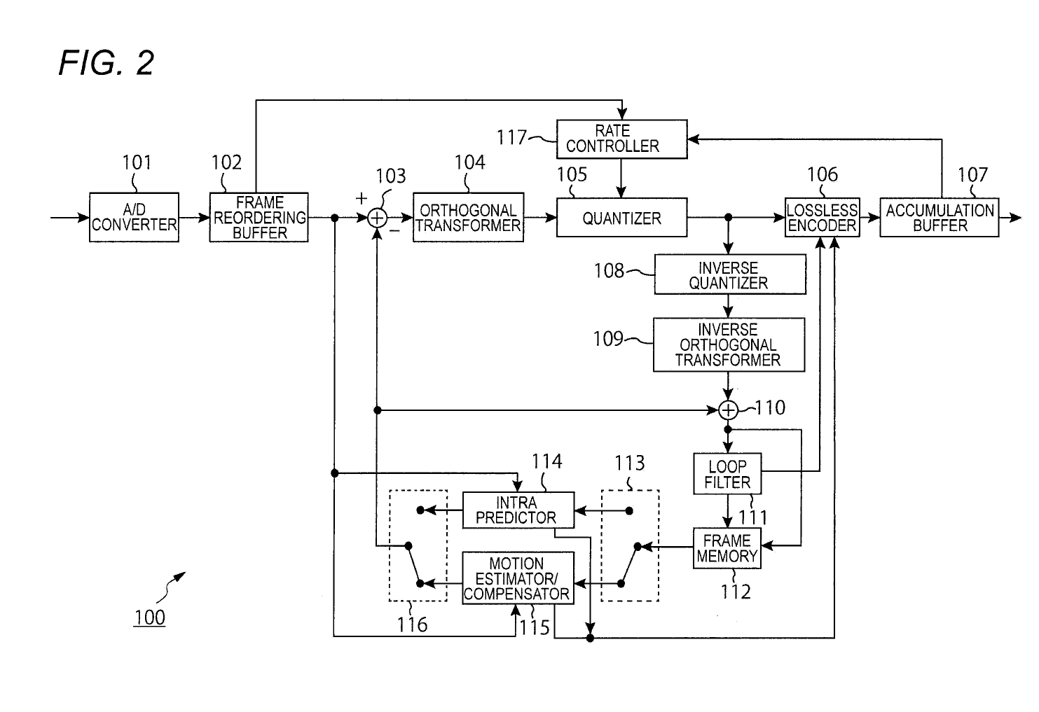

The accumulation buffer 201 accumulates transmitted encoded data, and supplies the encoded data to the lossless decoder 202 at a predetermined time. The lossless decoder 202 decodes information that is encoded by the lossless encoder 106 shown in FIG. 2 and is supplied from the accumulation buffer 201, by a method compatible with the encoding method used by the lossless encoder 106. The lossless decoder 202 supplies quantized coefficient data of a difference image obtained by the decoding to the inverse quantizer 203.

The lossless decoder 202 also determines whether the selected optimum prediction mode is an intra prediction mode and whether the selected optimum prediction mode is an inter prediction mode, by referring to optimum prediction mode information obtained by decoding the encoded data. Specifically, the lossless decoder 202 determines whether the prediction mode used in the transmitted encoded data is an intra prediction mode and whether the prediction mode is an inter prediction mode.

Based on a result of the determination, the lossless decoder 202 supplies the information about the prediction mode to the intra predictor 211 or the motion estimator/compensator 212. For example, in a case where an intra prediction mode is selected as the optimum prediction mode in the image encoding device 100, the lossless decoder 202 supplies intra prediction information that is supplied from the encoding side and is the information about the selected intra prediction mode, to the intra predictor 211. In a case where an inter prediction mode is selected as the optimum prediction mode in the image encoding device 100, the lossless decoder 202 supplies inter prediction information that is supplied from the encoding side and is the information about the selected inter prediction mode, to the motion estimator/compensator 212.

The inverse quantizer 203 inversely quantizes the quantized coefficient data obtained by the decoding performed by the lossless decoder 202, using quantization parameters supplied from the image encoding device 100. Specifically, the inverse quantizer 203 performs inverse quantization by a method compatible with the quantization method used by the quantizer 105 shown in FIG. 2. At this point, independently of the inverse quantization process for the texture image, the inverse quantizer 203 performs an inverse quantization process for the depth image turned into components together with the texture image. By doing so, the inverse quantizer 203 can perform a more appropriate inverse quantization process.

The inverse quantizer 203 supplies the coefficient data obtained through the inverse quantization of the respective components to the inverse orthogonal transformer 204.

The inverse orthogonal transformer 204 performs inverse orthogonal transform on the coefficient data supplied from the inverse quantizer 203 by a method compatible with the orthogonal transform method used by the orthogonal transformer 104 shown in FIG. 2. Through this inverse orthogonal transform process, the inverse orthogonal transformer 204 obtains difference data corresponding to the difference image yet to be subjected to orthogonal transform in the image encoding device 100.

The difference image obtained by the inverse orthogonal transform is supplied to the arithmetic operation unit 205. A predicted image is also supplied to the arithmetic operation unit 205 from the intra predictor 211 or the motion estimator/compensator 212 via the selector 213.

The arithmetic operation unit 205 adds the difference image to the predicted image, and obtains a reconstructed image corresponding to the image before the predicted image subtraction performed by the arithmetic operation unit 103 of the image encoding device 100. The arithmetic operation unit 205 supplies the reconstructed image to the loop filter 206.

The loop filter 206 performs a loop filtering process including deblocking filtering, adaptive loop filtering, and the like on the supplied reconstructed image as necessary, to generate a decoded image. For example, the loop filter 206 performs deblocking filtering on the reconstructed image to remove block distortion. Also, the loop filter 206 performs loop filtering on the result of the deblocking filtering (the reconstructed image from which block distortion has been removed) by using a Wiener filter, for example, to improve image quality.

Any type of filtering may be performed by the loop filter 206, and filtering other than the above mentioned types may be performed. The loop filter 206 may also perform filtering by using a filter coefficient supplied from the image encoding device 100 shown in FIG. 2.

The loop filter 206 supplies the decoded image that is the result of the filtering to the frame reordering buffer 207 and the frame memory 209. It should be noted that the filtering by the loop filter 206 may be skipped. In other words, the output of the arithmetic operation unit 205 may not be subjected to filtering, and be stored directly into the frame memory 209. For example, the intra predictor 211 uses the pixel values of pixels included in this image as the pixel values of peripheral pixels.

The frame reordering buffer 207 performs reordering on the supplied decoded image. Specifically, the frame sequence reordered in the encoding order by the frame reordering buffer 102 shown in FIG. 2 is reordered in the original display order. The D/A converter 208 performs D/A conversion on the decoded image supplied from the frame reordering buffer 207, and outputs the converted image to a display (not shown) to display the image.

The frame memory 209 stores the supplied reconstructed image and decoded image. The frame memory 209 also supplies the stored reconstructed image and decoded image to the intra predictor 211 and the motion estimator/compensator 212 via the selector 210 at a predetermined time or in response to a request from an outside unit such as the intra predictor 211 and the motion estimator/compensator 212.

The intra predictor 211 basically performs the same processing as the intra predictor 114 shown in FIG. 2. However, the intra predictor 211 performs intra predictions only on regions where predicted images have been generated through intra predictions at the time of encoding.

The motion estimator/compensator 212 performs an inter motion estimation process based on the inter prediction information supplied from the lossless decoder 202, to generate a predicted image. Based on the inter prediction information supplied from the lossless decoder 202, the motion estimator/compensator 212 performs the inter motion estimation process only on the regions where inter predictions have been performed at the time of encoding.

The intra predictor 211 or the motion estimator/compensator 212 supplies a generated predicted image for each region of prediction processing units to the arithmetic operation unit 205 via the selector 213.

The selector 213 supplies the predicted image supplied from the intra predictor 211 or the predicted image supplied from the motion estimator/compensator 212 to the arithmetic operation unit 205.

In the above described processes other than the inverse quantization process, parameters shared among components are basically used. In this manner, the image decoding device 200 can further increase encoding efficiency.

[Inverse Quantizer]

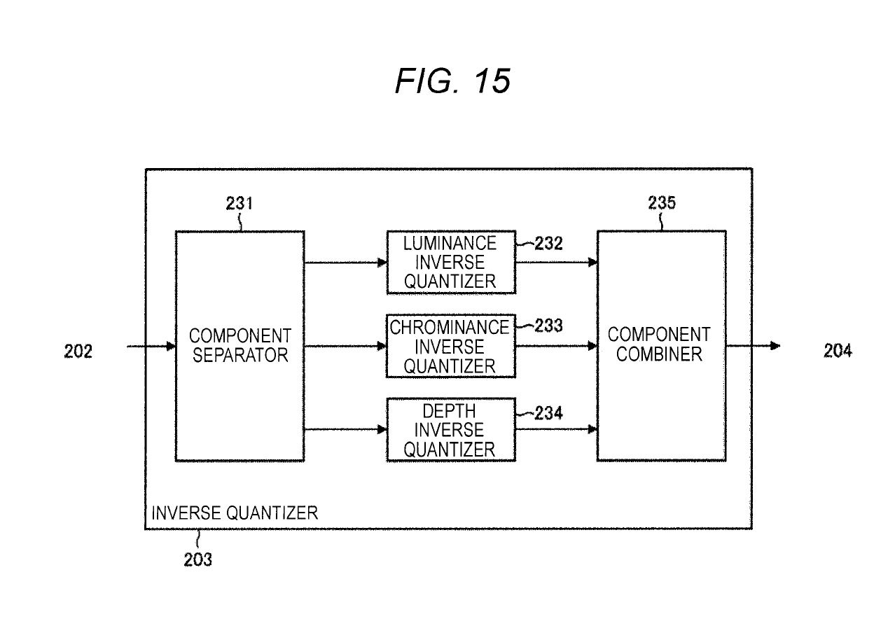

FIG. 15 is a block diagram showing a typical example structure of the inverse quantizer 203 shown in FIG. 14. As shown in FIG. 15, the inverse quantizer 203 includes a component separator 231, a luminance inverse quantizer 232, a chrominance inverse quantizer 233, a depth inverse quantizer 234, and a component combiner 235.

For each component, the component separator 231 separates the quantized coefficient data of a difference image that is obtained by the lossless decoder 202 performing decoding and is supplied from the lossless decoder 202.

The luminance inverse quantizer 232 performs inverse quantization on the luminance component of the quantized coefficient data extracted by the component separator 231, and supplies the coefficient data of the resultant luminance component to the component combiner 235.

The chrominance inverse quantizer 233 performs inverse quantization on the chrominance component of the quantized coefficient data extracted by the component separator 231, and supplies the coefficient data of the resultant chrominance component to the component combiner 235.

The depth inverse quantizer 234 performs inverse quantization on the depth component of the quantized coefficient data extracted by the component separator 231, and supplies the coefficient data of the resultant depth component to the component combiner 235.

The component combiner 235 combines the coefficient data of the respective components supplied from the luminance inverse quantizer 232 through the depth inverse quantizer 234, and supplies the combined coefficient data to the inverse orthogonal transformer 204.

[Depth Inverse Quantizer]

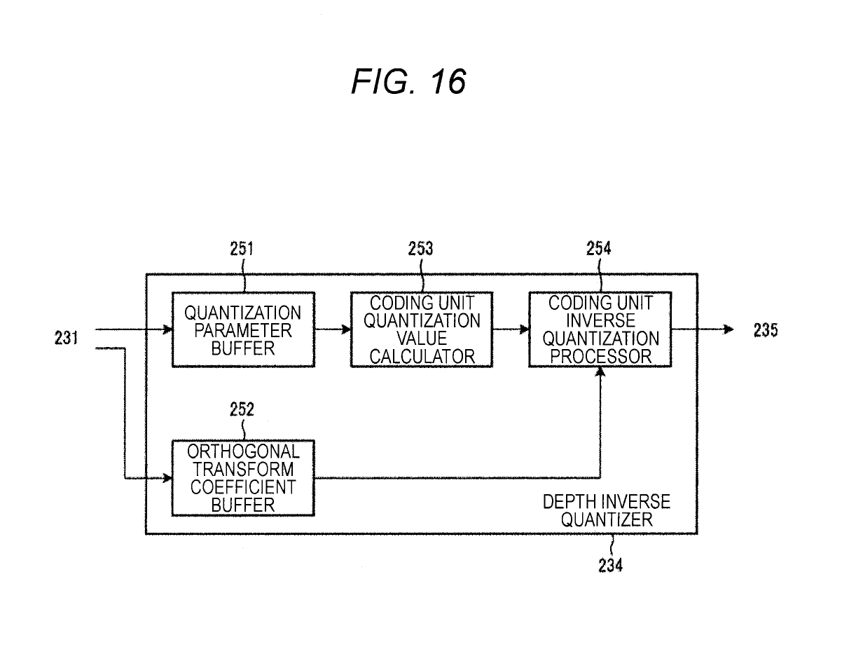

FIG. 16 is a block diagram showing a typical example structure of the depth inverse quantizer 234 shown in FIG. 15.

As shown in FIG. 16, the depth inverse quantizer 234 includes a quantization parameter buffer 251, an orthogonal transform coefficient buffer 252, a coding unit quantization value calculator 253, and a coding unit inverse quantization processor 254.

Parameters related to depth image quantization in respective layers such as the picture parameter set and the slice header of encoded data supplied from the image encoding device 100 are decoded by the lossless decoder 202, and are then supplied to the quantization parameter buffer 251. The quantization parameter buffer 251 holds the quantization parameters of the depth image as appropriate, and supplies the quantization parameters to the coding unit quantization value calculator 253 at a predetermined time.

Using the quantization parameters supplied from the quantization parameter buffer 251, the coding unit quantization value calculator 253 calculates the quantization value of each coding unit of the depth image, and supplies the quantization values to the coding unit inverse quantization processor 254.

The quantized orthogonal transform coefficient of the depth image obtained by the lossless decoder 202 decoding the encoded data supplied from the image encoding device 100 is supplied to the orthogonal transform coefficient buffer 252. The orthogonal transform coefficient buffer 252 holds the quantized orthogonal transform coefficient as appropriate, and supplies the quantized orthogonal transform coefficient to the coding unit inverse quantization processor 254 at a predetermined time.

Using the quantization value of each coding unit of the depth image supplied from the coding unit quantization value calculator 253, the coding unit inverse quantization processor 254 inversely quantizes the quantized orthogonal transform coefficient supplied from the orthogonal transform coefficient buffer 252. The coding unit inverse quantization processor 254 supplies the orthogonal transform coefficient of the depth image obtained by the inverse quantization to the component combiner 235.

As described above, independently of the texture image, the inverse quantizer 203 performs inverse quantization on the depth image turned into components together with the texture image, using quantization parameters that have been set independently of the texture image. Accordingly, a more appropriate inverse quantization process can be performed.

Also, the inverse quantizer 203 can perform an inverse quantization process, using the quantization values calculated for the respective coding units. Accordingly, the image decoding device 200 can perform an inverse quantization process more suited to the content of the image. Particularly, even in a case where the macroblock size is enlarged, and a single macroblock includes both a flat area and a texture-containing area, the image decoding device 200 can perform an adaptive inverse quantization process suitable for the respective areas, and prevent degradation of subjective image quality of the decoded image.

It should be noted that the inverse quantizer 108 of the image encoding device 100 shown in FIG. 1 has the same structure as the inverse quantizer 203, and performs the same processing. However, the inverse quantizer 108 acquires quantization parameters and a quantized orthogonal transform coefficient supplied from the quantizer 105, and then performs inverse quantization.

[Flow of Decoding Process]

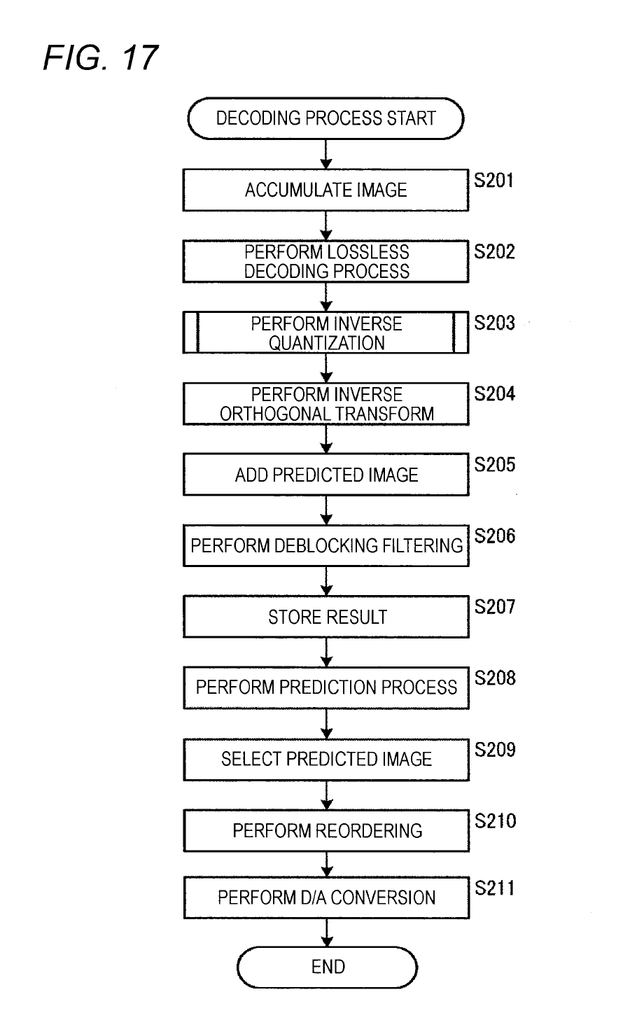

Next, flows of respective processes to be performed by the above described image decoding device 200 are described. Referring first to the flowchart shown in FIG. 17, an example flow of a decoding process is described.

When the decoding process is started, the accumulation buffer 201 accumulates transmitted encoded data in step S201. In step S202, the lossless decoder 202 decodes the encoded data supplied from the accumulation buffer 201. Specifically, I-pictures, P-pictures, and B-pictures encoded by the lossless encoder 106 shown in FIG. 2 are decoded.

At this point, motion vector information, reference frame information, prediction mode information (an intra prediction mode or an inter prediction mode), and information such as flag and quantization parameters are decoded.

In a case where the prediction mode information is intra prediction mode information, the prediction mode information is supplied to the intra predictor 211. In a case where the prediction mode information is inter prediction mode information, the prediction mode information and the corresponding motion vector information are supplied to the motion estimator/compensator 212. For these pieces of information, values shared among respective components are basically used.

In step S203, the inverse quantizer 203 inversely quantizes a quantized orthogonal transform coefficient obtained as a result of the decoding by the lossless decoder 202. Using quantization parameters supplied from the image encoding device 100, the inverse quantizer 203 performs an inverse quantization process. In doing so, the inverse quantizer 203 inversely quantizes the quantized orthogonal transform coefficient of the depth image, independently of the quantization process for the texture image, using the quantization parameters of the respective coding units of the depth image that have been supplied from the image encoding device 100 and been set independently of the quantization parameters of the texture image.

In step S204, the inverse orthogonal transformer 204 performs inverse orthogonal transform on the orthogonal transform coefficient obtained as a result of the inverse quantization performed by the inverse quantizer 203, by a method compatible with the method used by the orthogonal transformer 104 shown in FIG. 2. As a result, the difference information corresponding to the input to the orthogonal transformer 104 (or the output from the arithmetic operation unit 103) shown in FIG. 2 is decoded.

In step S205, the arithmetic operation unit 205 adds a predicted image to the difference information obtained by the processing in step S204. In this manner, the original image data is decoded.

In step S206, the loop filter 206 performs, as necessary, a loop filtering process including deblocking filtering, adaptive loop filtering, and the like on the reconstructed image obtained in step S205.

In step S207, the frame memory 209 stores the decoded image subjected to the filtering.

In step S208, the intra predictor 211 or the motion estimator/compensator 212 performs an image prediction process in accordance with the prediction mode information supplied from the lossless decoder 202.

Specifically, in a case where intra prediction mode information is supplied from the lossless decoder 202, the intra predictor 211 performs an intra prediction process in an intra prediction mode. In a case where inter prediction mode information is supplied from the lossless decoder 202, the motion estimator/compensator 212 performs a motion estimation process in an inter prediction mode.

In step S209, the selector 213 selects a predicted image. Specifically, the predicted image generated by the intra predictor 211 or the predicted image generated by the motion estimator/compensator 212 is supplied to the selector 213. The selector 213 selects the supplied one of the predicted images, and supplies the selected predicted image to the arithmetic operation unit 205. This predicted image is added to the difference information by the processing in step S205.

In step S210, the frame reordering buffer 207 reorders the frames of the decoded image data. Specifically, in the decoded image data, the order of frames reordered for encoding by the frame reordering buffer 102 of the image encoding device 100 (FIG. 2) is reordered in the original display order.

In step S211, the D/A converter 208 performs D/A conversion on the decoded image data having the frames reordered by the frame reordering buffer 207. The decoded image data is output to a display (not shown), and the image is displayed.

[Flow of the Inverse Quantization Process]

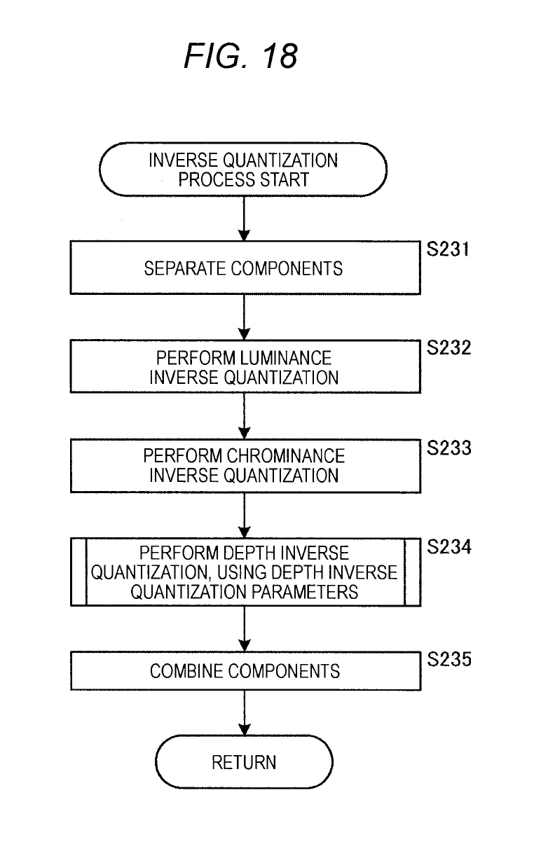

Referring now to the flowchart shown in FIG. 18, an example flow of the inverse quantization process performed in step S203 in FIG. 17 is described.

When the inverse quantization process is started, the component separator 231 in step S231 separates the quantized coefficient data for each component. In step S232, the luminance inverse quantizer 232 performs inverse quantization on the luminance component. In step S233, the chrominance inverse quantizer 233 performs inverse quantization on the chrominance component.

In step S234, the depth inverse quantizer 234 performs inverse quantization on the depth component, using the quantization parameters of the depth image.

In step S235, the component combiner 235 combines the results (coefficient data) of the inverse quantization performed on the respective components in steps S232 through S234. After the processing in step S235 is completed, the inverse quantizer 203 returns to the process in FIG. 17.

[Flow of the Depth Inverse Quantization Process]

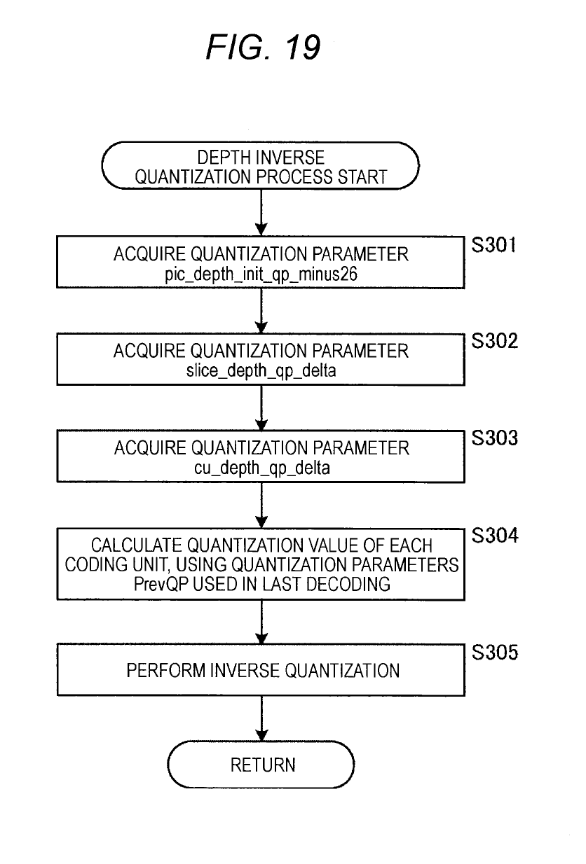

Referring now to the flowchart shown in FIG. 19, an example flow of the depth inverse quantization process performed in step S234 in FIG. 18 is described.

When the depth inverse quantization process is started, the quantization parameter buffer 251 in step S301 acquires the quantization parameter pic_depth_init_qp_minus26 of each picture (current picture) supplied from the lossless decoder 202 for the depth image.

In step S302, the quantization parameter buffer 251 acquires the quantization parameter slice_depth_qp_delta of each slice (current slice) supplied from the lossless decoder 202 for the depth image.

In step S303, the quantization parameter buffer 251 acquires the quantization parameter cu_delta_qp_delta of each coding unit supplied from the lossless decoder 202 for the depth image.

In step S304, the coding unit quantization value calculator 253 calculates the quantization value of each coding unit, using the respective quantization parameters acquired by the processing in steps S301 through S303 and the last-used quantization parameters PrevQP.

In step S305, the coding unit inverse quantization processor 254 inversely quantizes the quantized orthogonal coefficient held in the orthogonal transform coefficient buffer 252, using the quantization value of each coding unit calculated by the processing in step S304.

After the processing in step S305 is completed, the depth inverse quantizer 234 returns to the decoding process, and the subsequent processing is performed.

By performing the respective processes as described above, the image decoding device 200 can perform an inverse quantization process by using the quantization values calculated for the respective coding units of the depth image, independently of the texture image, and can perform an inverse quantization process more suited to the content of the image.

### 3. Third Embodiment

Furthermore, it may be possible to control whether quantization parameters of the depth image are set independently of the texture image. For example, the image encoding device 100 may set and transmit a quantization parameter (flag information) cu_depth_qp_present_flag indicating whether there are quantization parameters of the depth image set independently of the texture image (whether quantization parameters of the depth image are transmitted), and the image decoding device 200 may control the inverse quantization process based on the value of this parameter.

[Flow of the Depth Quantization Parameter Calculation Process]

In this case, the encoding process and the quantization parameter calculation process are performed in the same manner as in the first embodiment.

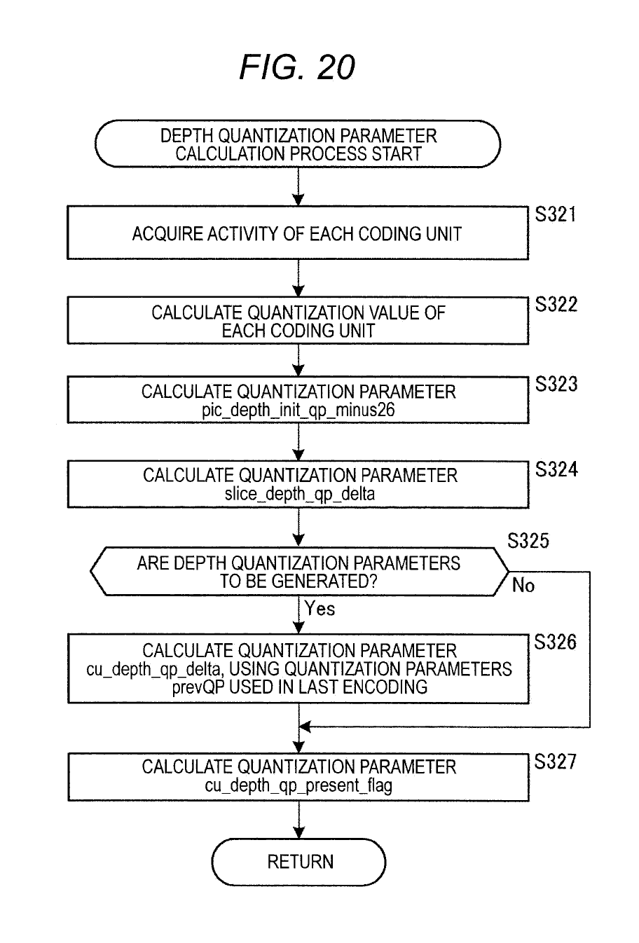

Referring now to the flowchart shown in FIG. 20, an example flow of the depth quantization parameter calculation process is described.

The processing in steps S321 through S324 is the same as the processing in steps S151 through S154 (FIG. 12) described in the first embodiment.

In step S325, the coding unit quantization parameter calculator 154 determines whether to generate quantization parameters of the depth image. When determining that the coding unit being processed (the current coding unit) is an important region in the depth image, and quantization parameters are preferably set independently of the texture image, the coding unit quantization parameter calculator 154 moves on to step S325.

The coding unit quantization parameter calculator 154 performs the processing in step S326 in the same manner as the processing in step S155 (FIG. 12) described in the first embodiment. After the processing in step S326 is completed, the coding unit quantization parameter calculator 154 moves on to step S327.

When determining in step S325 that the coding unit being processed (the current coding unit) is not an important region in the depth image, and quantization parameters shared with the texture image will suffice, the coding unit quantization parameter calculator 154 moves on to step S327.

In step S327, the coding unit quantization parameter calculator 154 sets a quantization parameter cu_depth_qp_preent_flag. In a case where quantization parameters of the respective coding units of the depth image are set independently of the texture image, the coding unit quantization parameter calculator 154 sets the value of the quantization parameter cu_depth_qp_preent_flag to “1”. In a case where the coding units of the depth image have been quantized by using the quantization parameters shared with the texture image, the coding unit quantization parameter calculator 154 sets the value of the quantization parameter cu_depth_qp_preent_flag to “0”.

After setting the value of the quantization parameter cu_depth_qp_preent_flag, the coding unit quantization parameter calculator 154 ends the depth quantization parameter calculation process, and returns to the process in FIG. 11.

[Flow of the Quantization Process]

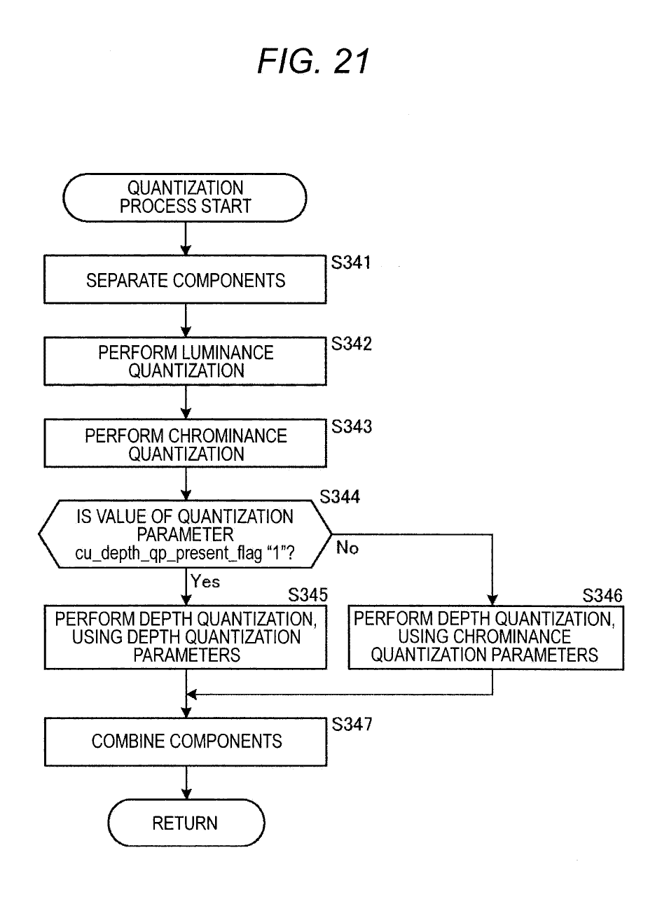

Referring now to the flowchart in FIG. 21, an example flow of the quantization process to be performed in this case is described.

The processing in steps S341 through S343 is performed in the same manner as the processing in steps S171 through S173 (FIG. 13).

In step S344, the depth quantizer 135 determines whether the value of the quantization parameter cu_depth_qp_prezent_flag is “1”. If the value is “1”, the depth quantizer 135 moves on to step S345.

The processing in step S345 is performed in the same manner as in step S174 (FIG. 13). After the processing in step S345 is completed, the depth quantizer 135 moves on to step S347.

If the value is determined to be “0” in step S344, on the other hand, the depth quantizer 135 moves on to step S346, and performs depth quantization by using the quantization parameters of the texture image (such as a chrominance image). After the processing in step S346 is completed, the depth quantizer 135 moves on to step S347.

The processing in step S347 is performed in the same manner as in step S175 (FIG. 13).

By performing the processing as described above, the image encoding device 100 can set quantization parameters of the depth image only at important portions where image quality degradation can be easily noticed, independently of the texture image, and can perform a quantization process on the depth image by using the quantization parameters, independently of the texture image. Accordingly, the image encoding device 100 can perform more appropriate quantization processes, and prevent degradation of subjective image quality of decoded images.

[Flow of the Depth Inverse Quantization Process]

Next, the processing to be performed by the image decoding device 200 is described. The decoding process and the inverse quantization process to be performed by the image decoding device 200 are the same as those in the first embodiment.

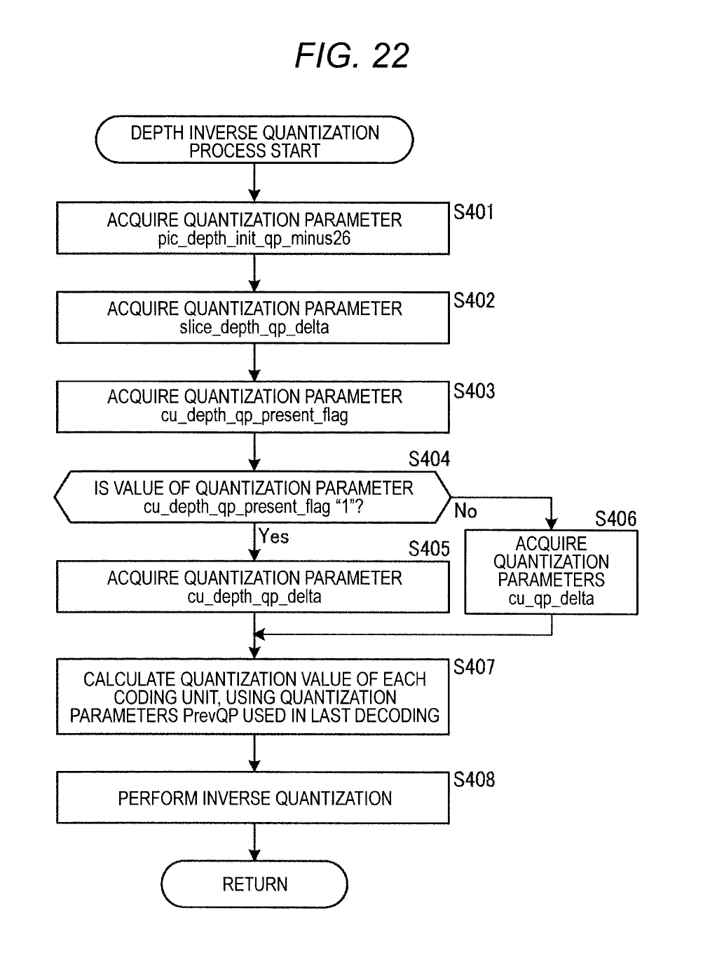

Referring now to the flowchart shown in FIG. 22, an example flow of the depth inverse quantization process to be performed in this case is described.

The processing in steps S401 and S402 is performed in the same manner as the processing in steps S301 and S302.

In step S403, the quantization parameter buffer 251 acquires the quantization parameter cu_depth_qp_present_flag that is transmitted from the image encoding device 100 and is supplied from the component separator 231. In step S404, the coding unit quantization value calculator 253 determines whether the value of the acquired quantization parameter cu_depth_qp_present_flag is “1”. If it is determined that the value is “1”, or there is a quantization parameter cu_depth_qp_delta set for the depth image independently of the texture image, the process moves on to step S405.

The processing in step S405 is performed in the same manner as the processing in step S303. After the processing in step S405 is completed, the process moves on to step S407.

If it is determined in step S404 that the value of the quantization parameter cu_depth_qp_present_flag is “0”, and there are no quantization parameters cu_depth_qp_delta set for the depth image independently of the texture image, the process moves on to step S406.

In step S406, the quantization parameter buffer 251 acquires quantization parameters cu_qp_delta of the texture image. After the processing in step S406 is completed, the process moves on to step S407.

The processing in steps S407 and S408 are performed in the same manner as the processing in steps S304 and S305. In step S407, however, the coding unit quantization value calculator 253 calculates quantization values by using the quantization parameters acquired in step S405 or S406.

As described above, as the image encoding device 100 transmits the quantization parameter cu_depth_qp_prezent_flag indicating whether quantization parameters of the depth image have been set independently of the texture image to the decoding side, the image decoding device 200 can select the quantization parameters to be used for the inverse quantization based on the value of the quantization parameter cu_depth_qp_prezent_flag. That is, the image decoding device 200 can more readily perform more appropriate inverse quantization processes, and can prevent degradation of subjective image quality of decoded images.

In the above described embodiments, depth image quantization parameters are controlled for respective coding units, but any processing units other than coding units may be used. Also, the quantization parameter cu_depth_qp_present_flag may have any value. Further, the quantization parameter cu_depth_qp_present_flag may be stored in any location in encoded data.

### 4. Fourth Embodiment

### [Computer]

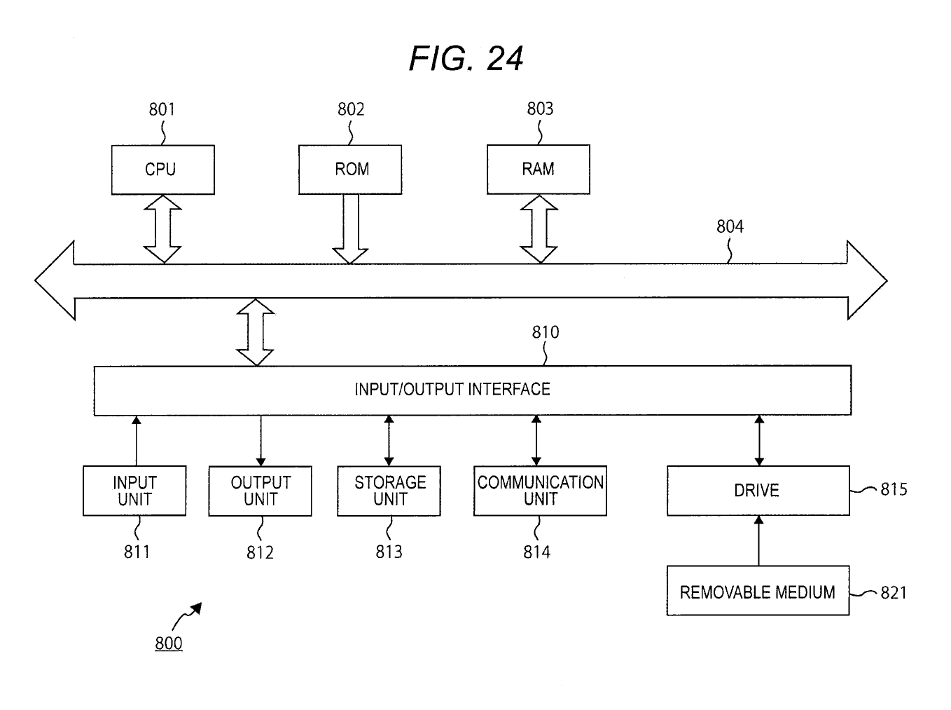

The above described series of processes can be performed by hardware or can be performed by software. In this case, the processes may be realized by a computer shown in FIG. 24, for example.

In FIG. 24, the CPU (Central Processing Unit) 801 of the computer 800 performs various kinds of processes in accordance with programs stored in a ROM (Read Only Memory) 802 or programs loaded from a storage unit 813 into a RAM (Random Access Memory) 803. The data necessary for the CPU 801 to perform various kinds of processes is also stored in the RAM 803 as necessary.

The CPU 801, the ROM 802, and the RAM 803 are connected to one another via a bus 804. An input/output interface 810 is also connected to the bus 804.

The input/output interface 810 has the following components connected thereto: an input unit 811 formed with a keyboard, a mouse, or the like; an output unit 812 formed with a display such as a CRT (Cathode Ray Tube) or a LCD (Liquid Crystal Display), and a speaker; the storage unit 813 formed with a hard disk or the like; and a communication unit 814 formed with a modem. The communication unit 814 performs communications via networks including the Internet.

A drive 815 is also connected to the input/output interface 810 where necessary, a removable medium 821 such as a magnetic disk, an optical disk, a magnetooptical disk, or a semiconductor memory is mounted on the drive as appropriate, and a computer program read from such a removable disk is installed in the storage unit 813 where necessary.

When the above described series of processes is performed by software, the programs constituting the software are installed from a network or a recording medium.

As shown in FIG. 24, this recording medium is formed with the removable medium 821 that is distributed for delivering the program to users separately from the device, such as a magnetic disk (including a flexible disk), an optical disk (including a CD-ROM (Compact Disc-Read Only Memory) or a DVD (Digital Versatile Disc)), a magnetooptical disk (including an MD (Mini Disc)), or a semiconductor memory, which has the program recorded thereon. Alternatively, the recording medium may be formed with the ROM 802 having the program recorded thereon or a hard disk included in the storage unit 813. Such a recording medium is incorporated beforehand into the device prior to the delivery to users.

The programs to be executed by the computer may be programs for performing processes in chronological order in accordance with the sequence described in this specification, or may be programs for performing processes in parallel or performing a process when necessary, such as when there is a call.

In this specification, steps describing programs to be recorded on a recording medium include processes to be performed in parallel or independently of one another if not necessarily in chronological order, as well as processes to be performed in chronological order in accordance with the sequence described herein.

In this specification, a “system” means an entire apparatus formed with two or more devices (apparatuses).

Also, any structure described above as one device (or one processor) may be divided into two or more devices (or processors). Conversely, any structure described above as two or more devices (or processors) may be combined into one device (or processor). Also, it is of course possible to add components other than those described above to the structure of any of the devices (or processors). Furthermore, some components of a device (or a processor) may be incorporated into the structure of another device (or another processor) as long as the structure and the function of the system as a whole remain substantially the same. That is, embodiments of the present technique are not limited to the above described embodiments, and various modifications may be made to them without departing from the scope of the technique.

The image encoding device 100 (FIG. 2) and the image decoding device 200 (FIG. 14) according to the above described embodiments can be applied to various electronic apparatuses including: transmitters or receivers for satellite broadcasting, cable broadcasting such as cable television, deliveries via the Internet, deliveries to terminals by cellular communications, and the like; recording apparatuses that record images on media such as optical disks, magnetic disks, or flash memories; or reproducing devices that reproduce images from those storage media. Four examples of applications will be described below.

### 5. Fifth Embodiment

### [Television Apparatus]

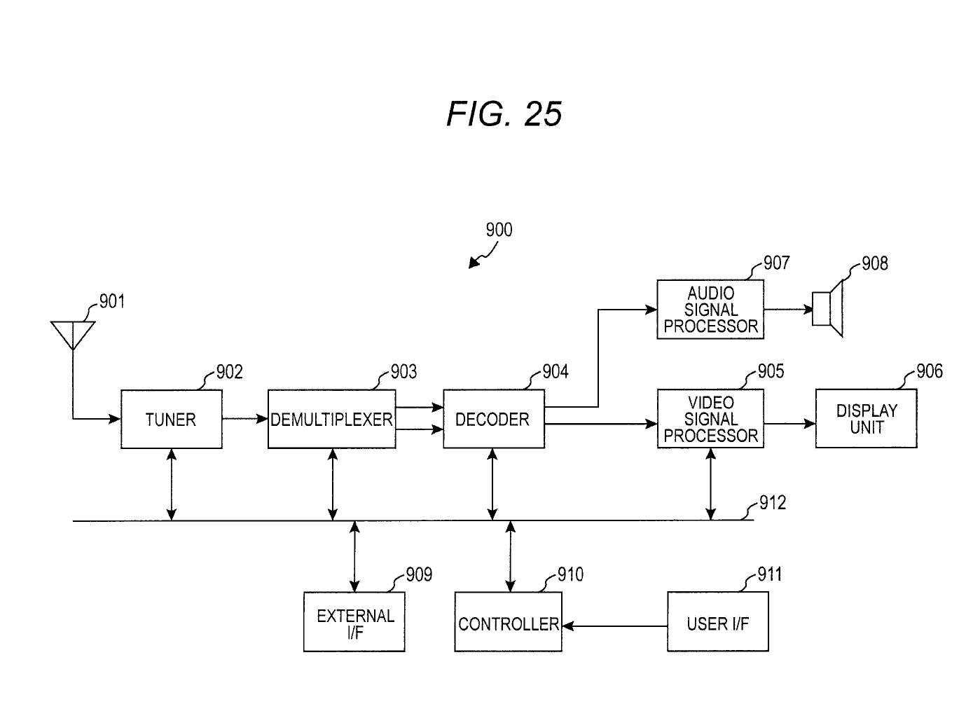

FIG. 25 schematically shows an example structure of a television apparatus to which the above described embodiments are applied. The television apparatus 900 includes an antenna 901, a tuner 902, a demultiplexer 903, a decoder 904, a video signal processor 905, a display unit 906, an audio signal processor 907, a speaker 908, an external interface 909, a controller 910, a user interface 911, and a bus 912.

The tuner 902 extracts a signal of a desired channel from broadcast signals received via the antenna 901, and demodulates the extracted signal. The tuner 902 then outputs an encoded bit stream obtained by the demodulation to the demultiplexer 903. That is, the tuner 902 serves as a transmitter in the television apparatus 900 that receives an encoded stream of encoded images.

The demultiplexer 903 separates a video stream and an audio stream of a program to be viewed from the encoded bit stream, and outputs the separated streams to the decoder 904. The demultiplexer 903 also extracts auxiliary data such as an EPG (Electronic Program Guide) from the encoded bit stream, and supplies the extracted data to the controller 910. If the encoded bit stream is scrambled, the demultiplexer 903 may descramble the encoded bit stream.

The decoder 904 decodes the video stream and the audio stream input from the demultiplexer 903. The decoder 904 then outputs video data generated by the decoding to the video signal processor 905. The decoder 904 also outputs audio data generated by the decoding to the audio signal processor 907.

The video signal processor 905 reproduces video data input from the decoder 904, and displays the video data on the display unit 906. The video signal processor 905 may also display an application screen supplied via the network on the display unit 906. Furthermore, the video signal processor 905 may perform additional processing such as denoising on the video data depending on settings. The video signal processor 905 may further generate an image of a GUI (Graphical User Interface) such as a menu, a button or a cursor and superimpose the generated image on the output images.

The display unit 906 is driven by a drive signal supplied from the video signal processor 905, and displays video or images on a video screen of a display device (such as a liquid crystal display, a plasma display, or an OELD (Organic Electroluminescence Display).

The audio signal processor 907 performs reproduction processing such as D/A conversion and amplification on the audio data input from the decoder 904, and outputs audio through the speaker 908. Furthermore, the audio signal processor 907 may perform additional processing such as denoising on the audio data.

The external interface 909 is an interface for connecting the television apparatus 900 with an external device or a network. For example, a video stream or an audio stream received via the external interface 909 may be decoded by the decoder 904. That is, the external interface 909 also serves as a transmitter in the television apparatus 900 that receives encoded streams formed with encoding images.

The controller 910 includes a processor such as a CPU, and a memory such as a RAM and a ROM. The memory stores programs to be executed by the CPU, program data, EPG data, data acquired via the network, and the like. The programs stored in the memory are read and executed by the CPU when the television apparatus 900 is activated, for example. By executing the programs, the CPU controls the operation of the television apparatus 900 according to control signals input from the user interface 911, for example.

The user interface 911 is connected to the controller 910. The user interface 911 includes buttons and switches for users to operate the television apparatus 900 and a receiving unit for receiving remote control signals, for example. The user interface 911 detects operation by a user via these components, generates a control signal, and outputs the generated control signal to the controller 910.

The bus 912 connects the tuner 902, the demultiplexer 903, the decoder 904, the video signal processor 905, the audio signal processor 907, the external interface 909, and the controller 910 to one another.

In the television apparatus 900 having such a structure, the decoder 904 has the functions of the image decoding device 200 (FIG. 14) according to the embodiments described above. For a depth image to be decoded by the television apparatus 900, a quantization value is calculated for each coding unit by using quantization parameters supplied for the depth image from the encoding side, and inverse quantization is then performed. Accordingly, an inverse quantization process more suited to the content to the depth image can also be performed, and degradation of subjective image quality of the decoded image can be prevented.

### 6. Sixth Embodiment

### [Portable Telephone Device]

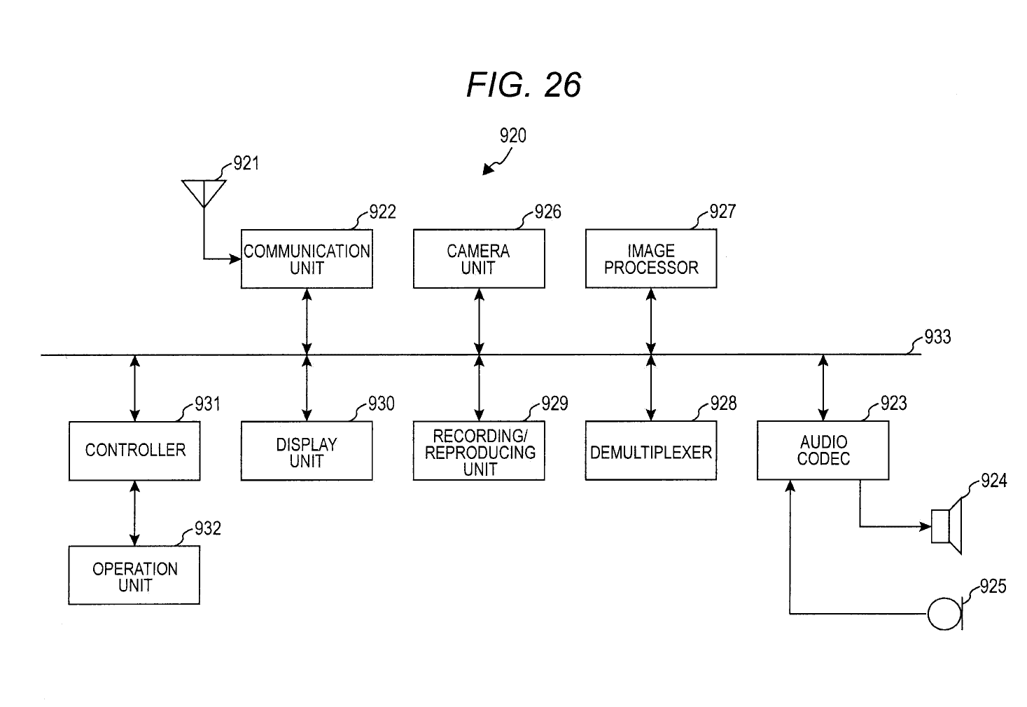

FIG. 26 schematically shows an example structure of a portable telephone device to which the above described embodiments are applied. The portable telephone device 920 includes an antenna 921, a communication unit 922, an audio codec 923, a speaker 924, a microphone 925, a camera unit 926, an image processor 927, a demultiplexer 928, a recording/reproducing unit 929, a display unit 930, a controller 931, an operation unit 932, and a bus 933.

The antenna 921 is connected to the communication unit 922. The speaker 924 and the microphone 925 are connected to the audio codec 923. The operation unit 932 is connected to the controller 931. The bus 933 connects the communication unit 922, the audio codec 923, the camera unit 926, the image processor 927, the demultiplexer 928, the recording/reproducing unit 929, the display unit 930, and the controller 931 to one another.

The portable telephone device 920 performs operation such as transmission/reception of audio signals, transmission/reception of electronic mails and image data, capturing of images, recording of data, and the like in various operation modes including a voice call mode, a data communication mode, an imaging mode, and a video telephone mode.

In the voice call mode, an analog audio signal generated by the microphone 925 is supplied to the audio codec 923. The audio codec 923 converts the analog audio signal to audio data, performs A/D conversion on the converted audio data, and compresses the audio data. The audio codec 923 outputs the compressed audio data to the communication unit 922. The communication unit 922 encodes and modulates the audio data to generate a signal to be transmitted. The communication unit 922 then transmits the generated signal to be transmitted to a base station (not shown) via the antenna 921. The communication unit 922 also performs amplification and frequency conversion on a radio signal received via the antenna 921, and obtains a received signal. The communication unit 922 then demodulates and decodes the received signal to generate audio data, and outputs the generated audio data to the audio codec 923. The audio codec 923 performs decompression and D/A conversion on the audio data, to generate an analog audio signal. The audio codec 923 then supplies the generated audio signal to the speaker 924 to output sound.

In the data communication mode, the controller 931 generates text data to be included in an electronic mail according to operation by a user via the operation unit 932, for example. The controller 931 also displays the text on the display unit 930. The controller 931 also generates electronic mail data in response to an instruction for transmission from a user via the operation unit 932, and outputs the generated electronic mail data to the communication unit 922. The communication unit 922 encodes and modulates the electronic mail data to generate a signal to be transmitted. The communication unit 922 then transmits the generated signal to be transmitted to a base station (not shown) via the antenna 921. The communication unit 922 also performs amplification and frequency conversion on a radio signal received via the antenna 921, and obtains a received signal. The communication unit 922 then demodulates and decodes the received signal to restore electronic mail data, and outputs the restored electronic mail data to the controller 931. The controller 931 displays the content of the electronic mail on the display unit 930, and stores the electronic mail data into a storage medium of the recording/reproducing unit 929.

The recording/reproducing unit 929 includes any readable/writable storage medium. For example, the storage medium may be an internal storage medium such as a RAM or flash memory, or may be an externally mounted storage medium such as a hard disk, a magnetic disk, a magnetooptical disk, an optical disk, a USB memory, or a memory card.

In the imaging mode, the camera unit 926 generates image data by capturing an image of an object, and outputs the generated image data to the image processor 927. The image processor 927 encodes the image data input from the camera unit 926, and stores the encoded stream into the storage medium in the recording/reproducing unit 929.

In the video telephone mode, the demultiplexer 928 multiplexes a video stream encoded by the image processor 927 and an audio stream input from the audio codec 923, and outputs the multiplexed stream to the communication unit 922, for example. The communication unit 922 encodes and modulates the stream, to generate a signal to be transmitted. The communication unit 922 then transmits the generated signal to be transmitted to a base station (not shown) via the antenna 921. The communication unit 922 also performs amplification and frequency conversion on a radio signal received via the antenna 921, and obtains a received signal. The signal to be transmitted and the received signal may include encoded bit streams. The communication unit 922 then demodulates and decodes the received signal to restore the stream, and outputs the restored stream to the demultiplexer 928. The demultiplexer 928 separates a video stream and an audio stream from the input stream, and outputs the video stream to the image processor 927 and the audio stream to the audio codec 923. The image processor 927 decodes the video stream to generate video data. The video data is supplied to the display unit 930, and a series of images is displayed by the display unit 930. The audio codec 923 performs decompression and D/A conversion on the audio stream, to generate an analog audio signal. The audio codec 923 then supplies the generated audio signal to the speaker 924 to output sound.

In the portable telephone device 920 having the above described structure, the image processor 927 has the functions of the image encoding device 100 (FIG. 2) and the image decoding device 200 (FIG. 14) according to the above described embodiments. For a depth image to be encoded and decoded by the portable telephone device 920, a quantization value is calculated for each coding unit, and orthogonal transform coefficient quantization is performed by using the quantization values of the respective coding units. In this manner, a quantization process more suited to the content of the depth image can also be performed, and encoded data can be generated so as to prevent degradation of subjective image quality of the decoded image. Also, a quantization value is calculated for each coding unit by using quantization parameters supplied for the depth image from the encoding side, and inverse quantization is then performed. Accordingly, an inverse quantization process more suited to the content to the depth image can also be performed, and degradation of subjective image quality of the decoded image can be prevented.

Although the portable telephone device 920 has been described above, an image encoding device and an image decoding device according to the present technique can also be applied to any device in the same manner as with the case of the portable telephone device 920, as long as the device has the same image capturing function and the same communication function as the portable telephone 920. Such a device may be a PDA (Personal Digital Assistants), a smartphone, an UMPC (Ultra Mobile Personal Computer), a netbook, or a notebook personal computer, for example.

### 7. Seventh Embodiment

### [Recording/Reproducing Device]

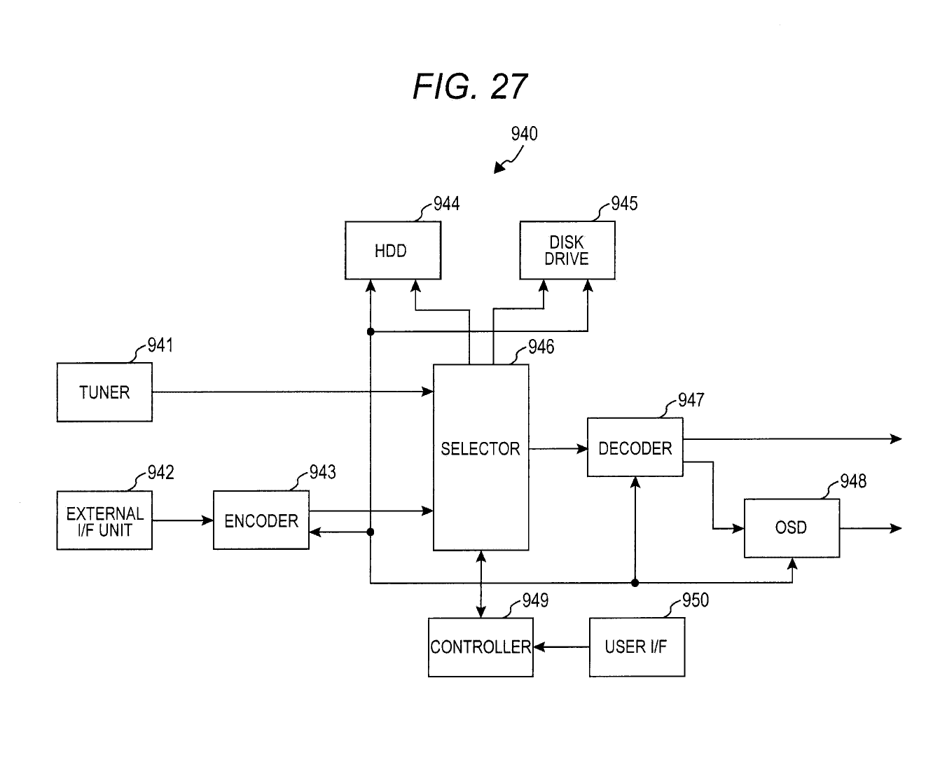

FIG. 27 schematically shows an example structure of a recording/reproducing device to which the above described embodiments are applied. The recording/reproducing device 940 encodes audio data and video data of a received broadcast program and records the encoded data on a recording medium, for example. The recording/reproducing device 940 may also encode audio data and video data acquired from another device and record the encoded data on a recording medium, for example. The recording/reproducing device 940 also reproduces data recorded on the recording medium with a monitor and a speaker in response to an instruction from a user, for example. In doing so, the recording/reproducing device 940 decodes audio data and video data.

The recording/reproducing device 940 includes a tuner 941, an external interface 942, an encoder 943, an HDD (Hard Disk Drive) 944, a disk drive 945, a selector 946, a decoder 947, an OSD (On-Screen Display) 948, a controller 949, and a user interface 950.

The tuner 941 extracts a signal of a desired channel from broadcast signals received via an antenna (not shown), and demodulates the extracted signal. The tuner 941 then outputs an encoded bit stream obtained by the demodulation to the selector 946. That is, the tuner 941 serves as a transmitter in the recording/reproducing device 940.

The external interface 942 is an interface for connecting the recording/reproducing device 940 to an external device or a network. The external interface 942 may be an IEEE 1394 interface, a network interface, a USB interface, or a flash memory interface, for example. For example, video data and audio data received via the external interface 942 are input to the encoder 943. That is, the external interface 942 serves as a transmitter in the recording/reproducing device 940.

The encoder 943 encodes the video data and the audio data if the video data and the audio data input from the external interface 942 are not encoded. The encoder 943 then outputs the encoded bit stream to the selector 946.

The HDD 944 records an encoded bit stream formed by compressing content data such as video images and sound, various programs, and other data on an internal hard disk. The HDD 944 also reads the data from the hard disk, to reproduce video and sound.

The disk drive 945 records data on and reads data from a recording medium mounted thereon. The recording medium mounted on the disk drive 945 may be a DVD disk (such as a DVD-Video, a DVD-RAM, a DVD-R, a DVD-RW, a DVD+R, or a DVD+RW) or a Blu-ray (registered trademark) disc, for example.

To record video and sound, the selector 946 selects an encoded bit stream input from the tuner 941 or the encoder 943, and outputs the selected encoded bit stream to the HDD 944 or the disk drive 945. To reproduce video and sound, the selector 946 outputs an encoded bit stream input from the HDD 944 or the disk drive 945, to the decoder 947.

The decoder 947 decodes the encoded bit stream to generate video data and audio data. The decoder 947 then outputs the generated video data to the OSD 948. The decoder 904 also outputs the generated audio data to an external speaker.

The OSD 948 reproduces the video data input from the decoder 947 and displays the video image. The OSD 948 may also superimpose an image of a GUI such as a menu, a button, or a cursor on the video to be displayed.

The controller 949 includes a processor such as a CPU, and a memory such as a RAM and a ROM. The memory stores programs to be executed by the CPU, program data, and the like. The programs stored in the memory are read and executed by the CPU when the recording/reproducing device 940 is activated, for example. By executing the programs, the CPU controls the operation of the recording/reproducing device 940 according to control signals input from the user interface 950, for example.

The user interface 950 is connected to the controller 949. The user interface 950 includes buttons and switches for users to operate the recording/reproducing device 940 and a receiving unit for receiving remote control signals, for example. The user interface 950 detects operation by a user via these components, generates a control signal, and outputs the generated control signal to the controller 949.

In the recording/reproducing device 940 having such a structure, the encoder 943 has the functions of the image encoding device 100 (FIG. 2) according to the embodiments described above. Furthermore, the decoder 947 has the functions of the image decoding device 200 (FIG. 14) according to the embodiments described above. For a depth image to be encoded and decoded by the recording/reproducing device 940, a quantization value is calculated for each coding unit, and orthogonal transform coefficient quantization is performed by using the quantization values of the respective coding units. In this manner, a quantization process more suited to the content of the depth image can also be performed, and encoded data can be generated so as to prevent degradation of subjective image quality of the decoded image. Also, a quantization value is calculated for each coding unit by using quantization parameters supplied for the depth image from the encoding side, and inverse quantization is then performed. Accordingly, an inverse quantization process more suited to the content to the depth image can also be performed, and degradation of subjective image quality of the decoded image can be prevented.

### 8. Eighth Embodiment

### [Imaging Device]

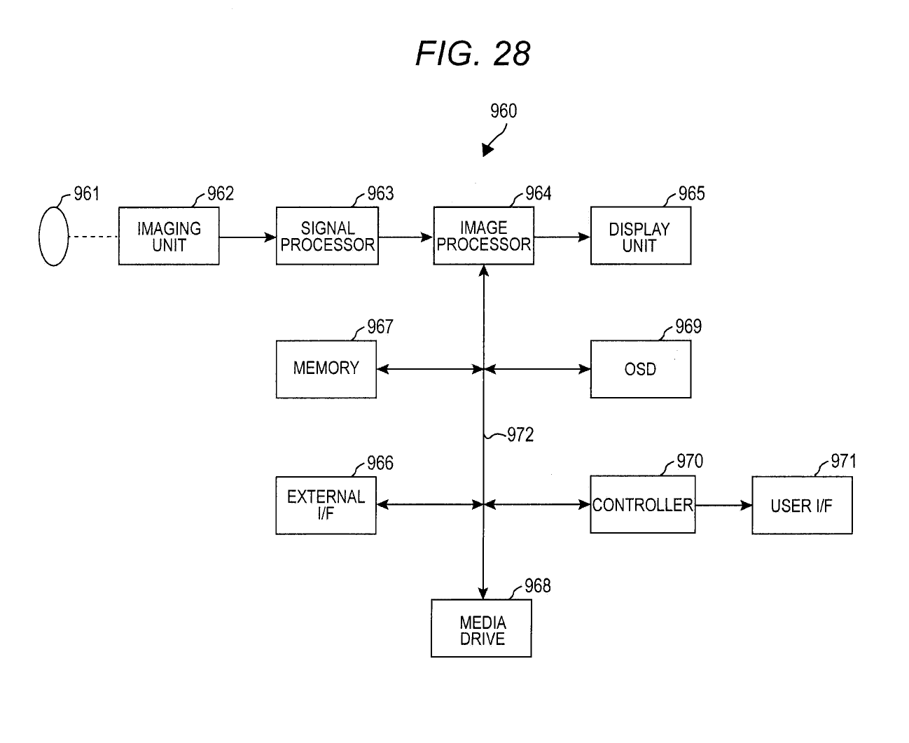

FIG. 28 schematically shows an example structure of an imaging device to which the above described embodiments are applied. The imaging device 960 generates an image by capturing an image of an object, encodes the image data, and records the encoded image data on a recording medium.

The imaging device 960 includes an optical block 961, an imaging unit 962, a signal processor 963, an image processor 964, a display unit 965, an external interface 966, a memory 967, a media drive 968, an OSD 969, a controller 970, a user interface 971, and a bus 972.

The optical block 961 is connected to the imaging unit 962. The imaging unit 962 is connected to the signal processor 963. The display unit 965 is connected to the image processor 964. The user interface 971 is connected to the controller 970. The bus 972 connects the image processor 964, the external interface 966, the memory 967, the media drive 968, the OSD 969, and the controller 970 to one another.

The optical block 961 includes a focus lens, a diaphragm, and the like. The optical block 961 forms an optical image of an object on the imaging surface of the imaging unit 962. The imaging unit 962 includes an image sensor such as a CCD or a CMOS, and converts the optical image formed on the imaging surface into an image signal as an electric signal through photoelectric conversion. The imaging unit 962 then outputs the image signal to the signal processor 963.

The signal processor 963 performs various kinds of camera signal processing such as knee correction, gamma correction, and color correction on the image signal input from the imaging unit 962. The signal processor 963 outputs image data subjected to the camera signal processing to the image processor 964.

The image processor 964 encodes the image data input from the signal processor 963, to generate encoded data. The image processor 964 then outputs the generated encoded data to the external interface 966 or the media drive 968. The image processor 964 also decodes encoded data input from the external interface 966 or the media drive 968, to generate image data. The image processor 964 then outputs the generated image data to the display unit 965. The image processor 964 may output image data input from the signal processor 963 to the display unit 965 to display images. The image processor 964 may also superimpose data for display acquired from the OSD 969 on the images to be output to the display unit 965.

The OSD 969 may generate an image of a GUI such as a menu, a button, or a cursor, and output the generated image to the image processor 964, for example.

The external interface 966 is designed as a USB input/output terminal, for example. The external interface 966 connects the imaging device 960 and a printer at the time of image printing, for example. A drive is also connected to the external interface 966, if necessary. A removable medium such as a magnetic disk or an optical disk is mounted on the drive, for example, and a program read out from the removable medium can be installed into the imaging device 960. Furthermore, the external interface 966 may be designed as a network interface connected to a network such as a LAN or the Internet. That is, the external interface 966 serves as a transmitter in the imaging device 960.

The recording medium to be mounted on the media drive 968 may be any readable/writable removable medium such as a magnetic disk, a magnetooptical disk, an optical disk or a semiconductor memory. Also, a recording medium may be mounted on the media drive 968 in a fixed manner, to form an immobile storage unit such as an internal hard disk drive or an SSD (Solid State Drive).

The controller 970 includes a processor such as a CPU, and a memory such as a RAM and a ROM. The memory stores programs to be executed by the CPU, program data, and the like. The programs stored in the memory are read and executed by the CPU when the imaging device 960 is activated, for example. By executing the programs, the CPU controls the operation of the imaging device 960 according to control signals input from the user interface 971, for example.

The user interface 971 is connected to the controller 970. The user interface 971 includes buttons and switches for users to operate the imaging device 960, for example. The user interface 971 detects operation by a user via these components, generates a control signal, and outputs the generated control signal to the controller 970.

In the imaging device 960 having the above described structure, the image processor 964 has the functions of the image encoding device 100 (FIG. 2) and the image decoding device 200 (FIG. 14) according to the above described embodiments. For a depth image to be encoded and decoded by the imaging device 960, a quantization value is calculated for each coding unit, and orthogonal transform coefficient quantization is performed by using the quantization values of the respective coding units. In this manner, a quantization process more suited to the content of the depth image can also be performed, and encoded data can be generated so as to prevent degradation of subjective image quality of the decoded image. Also, a quantization value is calculated for each coding unit by using quantization parameters supplied for the depth image from the encoding side, and inverse quantization is then performed. Accordingly, an inverse quantization process more suited to the content to the depth image can also be performed, and degradation of subjective image quality of the decoded image can be prevented.

It is of course possible to use an image encoding device and an image decoding device according to the present technique in any devices and systems other than the above described devices.

In this specification, example cases where quantization parameters are transmitted from the encoding side to the decoding side have been described. By a method of transmitting quantization matrix parameters, the quantization matrix parameters may not be multiplexed with an encoded bit stream, but may be transmitted or recorded as independent data associated with an encoded bit stream. Note that the term “associate” means to allow images (which may be part of images such as slices or blocks) contained in a bit stream to be linked with information on the images in decoding. That is, the information may be transmitted via a transmission path different from that for the images (or the bit stream). Alternatively, the information may be recorded on a recording medium other than that for the images (or the bit stream) (or in a different area of the same recording medium). Furthermore, the information and the images (or the bit stream) may be associated with each other in any unit such as a unit of some frames, one frame, or part of a frame.

While preferred embodiments of the present disclosure have been described above with reference to the accompanying drawings, the scope of the present disclosure is not limited to those examples. It should be apparent to those who have ordinary skills in the art of the present disclosure can make various changes or modifications within the scope of the technical spirit claimed herein, and it is naturally considered that those changes or modifications are within the technical scope of the present disclosure.

The present technique can also be in the following forms.

(1) An image processing device including:

a quantization value setter that sets a quantization value of a depth image independently of a texture image, the depth image being multiplexed with the texture image;

a quantizer that generates quantized data by quantizing coefficient data of the depth image, using the quantization value of the depth image set by the quantization value setter; and

an encoder that generates an encoded stream by encoding the quantized data generated by the quantizer.

(2) The image processing device of (1), wherein the quantization value setter sets a quantization value of the depth image for each predetermined region in the depth image.

(3) The image processing device of (2), wherein

the encoder performs the encoding for each unit having a hierarchical structure, and

the region is a coding unit.

(4) The image processing device of (3), further including:

a quantization parameter setter that sets a quantization parameter of a current picture of the depth image, using the quantization value of the depth image set by the quantization value setter; and

a transmitter that transmits the quantization parameter set by the quantization parameter setter, and the encoded stream generated by the encoder.

(5) The image processing device of (3) or (4), further including:

a difference quantization parameter setter that sets a difference quantization parameter that is a difference value between a quantization parameter of a current picture and a quantization parameter of a current slice, using the quantization value of the depth image set by the quantization value setter; and

a transmitter that transmits the difference quantization parameter set by the difference quantization parameter setter, and the encoded stream generated by the encoder.

(6) The image processing device of (5), wherein the difference quantization parameter setter sets the difference quantization parameter that is a difference value between a quantization parameter of a coding unit quantized one unit before a current coding unit and a quantization parameter of the current coding unit, using the quantization value of the depth image calculated by the quantization value setter.

(7) The image processing device of any of (1) through (6), further including:

an identification information setter that sets identification information indicating whether a quantization parameter of the depth image has been set; and

a transmitter that transmits the identification information set by the identification information setter and the encoded stream generated by the encoder.

(8) An image processing method for an image processing device, the method including:

setting a quantization value of a depth image independently of a texture image, the depth image being multiplexed with the texture image, the setting the quantization value of the depth image being performed by a quantization value setter;

generating quantized data by quantizing coefficient data of the depth image, using the set quantization value of the depth image, the generating the quantized data being performed by a quantizer; and

generating an encoded stream by encoding the quantized data generated by the quantizer, the generating the encoded stream being performed by an encoder.

(9) An image processing device including:

a receiver that receives a quantization value of a depth image set independently of a texture image, and an encoded stream generated by quantizing and encoding coefficient data of the depth image, the depth image being multiplexed with the texture image;

a decoder that decodes the encoded stream received by the receiver, to acquire quantized data generated by quantizing the coefficient data of the depth image; and

an inverse quantizer that inversely quantizes the quantized data acquired by the decoder, using the quantization value of the depth image received by the receiver.

(10) The image processing device of (9), wherein the receiver receives a quantization value of the depth image that is set for each predetermined region in the depth image.

(11) The image processing device of (10), wherein

the decoder decodes the encoded stream that is encoded for each unit having a hierarchical structure, and

the region is a coding unit.

(12) The image processing device of (11), wherein

the receiver receives the quantization value of the depth image as a quantization parameter of a current picture of the depth image, the quantization parameter of the current picture being set by using the quantization value of the depth image,

the image processing device further includes a quantization value setter that sets a quantization value of the depth image, using the quantization parameter of the current picture of the depth image received by the receiver, and

the inverse quantizer inversely quantizes the quantized data acquired by the decoder, using the quantization value of the depth image set by the quantization value setter.

(13) The image processing device of (11) or (12), wherein

the receiver receives the quantization value of the depth image as a difference quantization parameter that is a difference value between a quantization parameter of a current picture and a quantization parameter of a current slice, the quantization parameters of the current picture and the current slice being set by using the quantization value of the depth image,

the image processing device further includes a quantization value setter that sets a quantization value of the depth image, using the difference quantization parameter received by the receiver, and

the inverse quantizer inversely quantizes the quantized data acquired by the decoder, using the quantization value of the depth image set by the quantization value setter.

(14) The image processing device of (13), wherein the receiver receives the difference quantization parameter that is a difference value between a quantization parameter of the coding unit quantized one unit before a current coding unit and a quantization parameter of the current coding unit, the quantization parameters being set by using the quantization value of the depth image.

(15) The image processing device of any of (9) through (14), wherein

the receiver further receives identification information indicating whether a quantization parameter of the depth image has been set, and

the inverse quantizer inversely quantizes the coefficient data of the depth image only when the identification information indicates that a quantization parameter of the depth image has been set.

(16) An image processing method for an image processing device, the method including:

receiving a quantization value of a depth image set independently of a texture image, and an encoded stream generated by quantizing and encoding coefficient data of the depth image, the depth image being multiplexed with the texture image, the receiving the quantization value of the depth image and the encoded stream being performed by a receiver;

decoding the received encoded stream to acquire quantized data generated by quantizing the coefficient data of the depth image, the decoding the received encoded stream being performed by a decoder; and

inversely quantizing the acquired quantized data by using the received quantization value of the depth image, the inversely quantizing the acquired quantized data being performed by an inverse quantizer.

### REFERENCE SIGNS LIST

100 Image encoding device
105 Quantizer
108 Inverse quantizer
131 Component separator
132 Component separator
133 Luminance quantizer
134 Chrominance quantizer
135 Depth quantizer
136 Component combiner
151 Coding unit quantization value calculator
152 Picture quantization parameter calculator
153 Slice quantization parameter calculator
154 Coding unit quantization parameter calculator
155 Coding unit quantization processor
200 Image decoding device
203 Inverse quantizer
231 Component separator
232 Luminance inverse quantizer
233 Chrominance inverse quantizer
234 Depth inverse quantizer
235 Component combiner
251 Quantization parameter buffer
252 Orthogonal transform coefficient buffer
253 Coding unit quantization value calculator
254 Coding unit inverse quantization processor

1. An image processing device comprising:
a quantization value setter configured to set a quantization value of a depth image independently of a texture image, the depth image being multiplexed with the texture image;
a quantizer configured to generate quantized data by quantizing coefficient data of the depth image, using the quantization value of the depth image set by the quantization value setter; and
an encoder configured to generate an encoded stream by encoding the quantized data generated by the quantizer.

2. The image processing device according to claim 1, wherein the quantization value setter sets a quantization value of the depth image for each predetermined region in the depth image.

3. The image processing device according to claim 2, wherein
the encoder performs the encoding for each unit having a hierarchical structure, and
the region is a coding unit.

4. The image processing device according to claim 3, further comprising:
a quantization parameter setter configured to set a quantization parameter of a current picture of the depth image, using the quantization value of the depth image set by the quantization value setter; and
a transmitter configured to transmit the quantization parameter set by the quantization parameter setter, and the encoded stream generated by the encoder.

5. The image processing device according to claim 3, further comprising:
a difference quantization parameter setter configured to set a difference quantization parameter that is a difference value between a quantization parameter of a current picture and a quantization parameter of a current slice, using the quantization value of the depth image set by the quantization value setter; and
a transmitter configured to transmit the difference quantization parameter set by the difference quantization parameter setter, and the encoded stream generated by the encoder.

6. The image processing device according to claim 5, wherein the difference quantization parameter setter sets the difference quantization parameter that is a difference value between a quantization parameter of a coding unit quantized one unit before a current coding unit and a quantization parameter of the current coding unit, using the quantization value of the depth image calculated by the quantization value setter.

7. The image processing device according to claim 1, further comprising:
an identification information setter configured to set identification information indicating whether a quantization parameter of the depth image has been set; and
a transmitter configured to transmit the identification information set by the identification information setter and the encoded stream generated by the encoder.

8. An image processing method for an image processing device, the method comprising:
setting a quantization value of a depth image independently of a texture image, the depth image being multiplexed with the texture image, the setting the quantization value of the depth image being performed by a quantization value setter;
generating quantized data by quantizing coefficient data of the depth image, using the set quantization value of the depth image, the generating the quantized data being performed by a quantizer; and
generating an encoded stream by encoding the quantized data generated by the quantizer, the generating the encoded stream being performed by an encoder.

9. An image processing device comprising:
a receiver configured to receive a quantization value of a depth image set independently of a texture image, and an encoded stream generated by quantizing and encoding coefficient data of the depth image, the depth image being multiplexed with the texture image;
a decoder configured to decode the encoded stream received by the receiver, to acquire quantized data generated by quantizing the coefficient data of the depth image; and
an inverse quantizer configured to inversely quantize the quantized data acquired by the decoder, using the quantization value of the depth image received by the receiver.

10. The image processing device according to claim 9, wherein the receiver receives a quantization value of the depth image that is set for each predetermined region in the depth image.

11. The image processing device according to claim 10, wherein
the decoder decodes the encoded stream that is encoded for each unit having a hierarchical structure, and
the region is a coding unit.

12. The image processing device according to claim 11, wherein
the receiver receives the quantization value of the depth image as a quantization parameter of a current picture of the depth image, the quantization parameter of the current picture being set by using the quantization value of the depth image,
the image processing device further comprises a quantization value setter configured to set a quantization value of the depth image, using the quantization parameter of the current picture of the depth image received by the receiver, and
the inverse quantizer inversely quantizes the quantized data acquired by the decoder, using the quantization value of the depth image set by the quantization value setter.

13. The image processing device according to claim 11, wherein
the receiver receives the quantization value of the depth image as a difference quantization parameter that is a difference value between a quantization parameter of a current picture and a quantization parameter of a current slice, the quantization parameters of the current picture and the current slice being set by using the quantization value of the depth image,
the image processing device further comprises a quantization value setter configured to set a quantization value of the depth image, using the difference quantization parameter received by the receiver, and
the inverse quantizer inversely quantizes the quantized data acquired by the decoder, using the quantization value of the depth image set by the quantization value setter.

14. The image processing device according to claim 13, wherein the receiver receives the difference quantization parameter that is a difference value between a quantization parameter of a coding unit quantized one unit before a current coding unit and a quantization parameter of the current coding unit, the quantization parameters being set by using the quantization value of the depth image.

15. The image processing device according to claim 9, wherein
the receiver further receives identification information indicating whether a quantization parameter of the depth image has been set, and
the inverse quantizer inversely quantizes the coefficient data of the depth image only when the identification information indicates that a quantization parameter of the depth image has been set.

16. An image processing method for an image processing device, the method comprising:
receiving a quantization value of a depth image set independently of a texture image, and an encoded stream generated by quantizing and encoding coefficient data of the depth image, the depth image being multiplexed with the texture image, the receiving the quantization value of the depth image and the encoded stream being performed by a receiver;
decoding the received encoded stream to acquire quantized data generated by quantizing the coefficient data of the depth image, the decoding the received encoded stream being performed by a decoder; and
inversely quantizing the acquired quantized data by using the received quantization value of the depth image, the inversely quantizing the acquired quantized data being performed by an inverse quantizer.
